(19) United States
(12) Patent Application Publication
(10) Pub. No.: US 2026/0113214 A1
(43) Pub. Date: Apr. 23, 2026

(54) METHOD AND APPARATUS FOR PERFORMING PROXY REPLY TO ADDRESS REQUEST PACKET, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Yu Ching CHUNG, Suzhou, Jiangsu (CN); Bo Hsiung CHI, Suzhou, Jiangsu (CN); Xiang CHEN, Suzhou, Jiangsu (CN)

(21) Appl. No.: 19/159,276

(22) PCT Filed: Dec. 26, 2023
(86) PCT No.: PCT/CN2023/142081

§ 371 Date: Aug. 22, 2025

(30) Foreign Application Priority Data
Apr. 27, 2023 (CN) 202310467846.5

(51) Int. Cl. H04L 12/46; H04L 47/12; H04L 61/59

(52) U.S. Cl. CPC H04L 12/4633; H04L 47/12; H04L 61/59

(57) ABSTRACT

The present application provides a method for performing a proxy reply to an address request packet. The method includes: receiving a first detection packet sent by a second tunnel endpoint; obtaining first network addresses carried by the first detection packet, where the first detection packet is generated by the second tunnel endpoint based on the stored first network addresses, and the first network addresses are network addresses of one or more first devices corresponding to the second tunnel endpoint; and in response to receiving a first address request packet, obtaining a first target network address from the first network addresses and sending the first target network address to a second device to perform a proxy reply to the first address request packet, where the second device is a device that sends the first address request packet to the first tunnel endpoint.

### CROSS-REFERENCE TO RELATED APPLICATION

The present disclosure claims the priority of Chinese patent application filed on Apr. 27, 2023 before the CNIPA, China National Intellectual Property Administration with the application number of 202310467846.5, and the title of “METHODS AND APPARATUSES FOR PERFORMING PROXY REPLY TO ADDRESS REQUEST PACKET, ELECTRONIC DEVICE AND STORAGE MEDIUM”, which is incorporated herein in its entirety by reference.

### FIELD

The present disclosure relates to the field of communication technology, and more particularly to methods and apparatuses for performing a proxy reply to an address request packet, an electronic device, and a non-transitory readable storage medium.

### BACKGROUND

Virtual extensible Local Area Network (VXLAN) is a network virtualization technology. Access points of the VXLAN are virtual tunnel endpoints (VTEPs). A local device in the VXLAN network will send an address resolution protocol (ARP) request packet to a corresponding VTEP. The VTEP may obtain a network address of a target device requested by the ARP request packet from the VXLAN network, so that the local device and the target device can communicate based on the network address.

A communication network is generally configured with two types of tunnels: static tunnel and dynamic tunnel. In a VXLAN application scenario, when a VTEP in the static tunnel receives an ARP request packet, the VTEP broadcasts the ARP request packet, and the network address of the target device, such as a medium access control (MAC) address, is obtained from the VXLAN network through broadcasting. However, in a case where the VTEP receives a large number of ARP request packets and broadcasts the ARP request packets, the VXLAN network will be flooded with packets, resulting in the occupation of a large amount of network resources and a decline in network performance.

### SUMMARY

The present disclosure provides methods and apparatuses for performing a proxy reply to an address request packet, an electronic device, and a non-transitory readable storage medium, in order to solve the problem of packet flooding occupying a large amount of network resources and causing a decline in network performance.

In order to solve the above technical problems, the present disclosure is implemented as follows:

In a first aspect, some embodiments of the present disclosure propose a method for performing a proxy reply to an address request packet, applied to a first tunnel endpoint. The method includes:

receiving a first detection packet sent by a second tunnel endpoint;

obtaining first network addresses carried by the first detection packet, where the first detection packet is generated by the second tunnel endpoint based on the first network addresses stored by the second tunnel endpoint, and the first network addresses are network addresses of one or more first devices corresponding to the second tunnel endpoint; and

in response to receiving a first address request packet, obtaining a first target network address from the first network addresses and sending the first target network address to a second device to perform a proxy reply to the first address request packet, where the first target network address is a first network address requested by the first address request packet, and the second device is a device that sends the first address request packet to the first tunnel endpoint.

In some embodiments, the method further includes:

generating a second detection packet based on second network addresses stored by the first tunnel endpoint, where the second network addresses are network addresses of one or more third devices corresponding to the first tunnel endpoint;

sending the second detection packet to the second tunnel endpoint, where the second detection packet is configured for the second tunnel endpoint to obtain the second network addresses carried by the second detection packet, and in response to receiving a second address request packet, obtain a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint.

In some embodiments, a static tunnel is established between the first tunnel endpoint and the second tunnel endpoint, and the method further includes:

obtaining a tunnel name and a tunnel identifier of the static tunnel;

where generating the second detection packet based on the second network addresses stored by the first tunnel endpoint includes:

generating the second detection packet based on the second network addresses stored by the first tunnel endpoint, the tunnel name, and the tunnel identifier;

sending the second detection packet to the second tunnel endpoint includes:

determining a first target tunnel from a plurality of static tunnels corresponding to the first tunnel endpoint based on the tunnel name and the tunnel identifier; and

sending the second detection packet to the second tunnel endpoint through the first target tunnel.

In some embodiments, before generating the second detection packet based on the second network addresses stored by the first tunnel endpoint, the tunnel name, and the tunnel identifier, the method further includes:

establishing a session between the first tunnel endpoint and the second tunnel endpoint based on the tunnel name and the tunnel identifier;

where sending the second detection packet to the second tunnel endpoint through the first target tunnel includes:

sending the second detection packet to the second tunnel endpoint through the first target tunnel under a condition that the session is in a hold state.

In some embodiments, after obtaining the first network addresses carried by the first detection packet, the method further includes:

storing the first network addresses in a first database;

where obtaining the first target network address from the first network addresses and sending the first target network address to the second device includes:

obtaining the first target network address from the first network addresses stored in the first database and sending the first target network address to the second device.

In some embodiments, the method further includes:

in response to receiving a third detection packet sent by the second tunnel endpoint, updating the first network addresses stored in the first database based on latest first network addresses carried by the third detection packet to obtain an updated first database, where the third detection packet is generated by the second tunnel endpoint based on the latest first network addresses;

where obtaining the first target network address from the first network addresses stored in the first database includes:

obtaining the first target network address from the first network addresses stored in the updated first database.

In some embodiments, after updating the first network addresses stored in the first database based on the latest first network addresses carried by the third detection packet to obtain the updated first database, the method further includes:

setting a preset first timing parameter to zero, and controlling the first timing parameter to restart timing, where the first timing parameter is configured to characterize an unupdated duration of the first database; and

deleting the first network addresses stored in the first database in response to the first timing parameter being greater than a preset duration threshold.

In some embodiments, obtaining the first target network address from the first network addresses stored in the first database includes:

determining a first address identifier based on the first address request packet; and

obtaining a first network address corresponding to the first address identifier from the first network addresses stored in the first database based on the first address identifier, and determining the first network address as the first target network address.

In a second aspect, some embodiments of the present disclosure propose a method for performing a proxy reply to an address request packet, applied to a second tunnel endpoint. The method includes:

generating a first detection packet based on first network addresses stored by the second tunnel endpoint, where the first network addresses are network addresses of one or more first devices corresponding to the second tunnel endpoint;

sending the first detection packet to a first tunnel endpoint, where the first detection packet is configured for the first tunnel endpoint to obtain the first network addresses, and in response to receiving a first address request packet, obtain a first target network address from the first network addresses and send the first target network address to a second device to perform a proxy reply to the first address request packet, where the first target network address is a first network address requested by the first address request packet, and the second device is a device that sends the first address request packet to the first tunnel endpoint.

In some embodiments, the method further includes:

receiving a second detection packet sent by the first tunnel endpoint;

obtaining second network addresses carried by the second detection packet, where the second detection packet is generated by the first tunnel endpoint based on the second network addresses stored by first tunnel endpoint, and the second network addresses are network addresses of one or more third devices corresponding to the first tunnel endpoint; and

in response to receiving a second address request packet, obtaining a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint.

In some embodiments, a static tunnel is established between the first tunnel endpoint and the second tunnel endpoint, and the method further includes:

obtaining a tunnel name and a tunnel identifier of the static tunnel;

where generating the first detection packet based on the first network addresses stored by the second tunnel endpoint includes:

generating the first detection packet based on the first network addresses stored by the second tunnel endpoint, the tunnel name, and the tunnel identifier;

sending the first detection packet to the first tunnel endpoint includes:

determining a second target tunnel from a plurality of static tunnels corresponding to the second tunnel endpoint based on the tunnel name and the tunnel identifier; and

sending the first detection packet to the first tunnel endpoint through the second target tunnel.

In some embodiments, before generating the first detection packet based on the first network addresses stored by the second tunnel endpoint, the tunnel name, and the tunnel identifier, the method further includes:

establishing a session between the first tunnel endpoint and the second tunnel endpoint based on the tunnel name and the tunnel identifier;

where sending the first detection packet to the first tunnel endpoint through the second target tunnel includes:

sending the first detection packet to the first tunnel endpoint through the second target tunnel under a condition that the session is in a hold state.

In some embodiments, after obtaining the second network addresses carried by the second detection packet, the method further includes:

storing the second network addresses in a second database;

where obtaining the second target network address from the second network addresses and send the second target network address to the fourth device includes:

obtaining the second target network address from the second network addresses stored in the second database and sending the second target network address to the fourth device.

In some embodiments, the method further including:

in response to receiving a fourth detection packet sent by the first tunnel endpoint, updating the second network addresses stored in the second database based on latest second network addresses carried by the fourth detection packet to obtain an updated second database, wherein the fourth detection packet is generated by the first tunnel endpoint based on the latest second network addresses;

where obtaining the second target network address from the second network addresses stored in the second database includes:

obtaining the second target network address from the second network addresses stored in the updated second database.

In some embodiments, after updating the second network addresses stored in the second database based on the latest second network addresses carried by the fourth detection packet to obtain the updated second database, the method further includes:

setting a preset second timing parameter to zero, and controlling the second timing parameter to restart timing, where the second timing parameter is configured to characterize an unupdated duration of the second database; and

deleting the second network addresses stored in the second database in response to the second timing parameter being greater than a preset duration threshold.

In some embodiments, obtaining the second target network address from the second network addresses stored in the second database includes:

determining a second address identifier based on the second address request packet; and obtaining a second network address corresponding to the second address identifier from the second network addresses stored in the second database based on the second address identifier, and determining the second network address as the second target network address.

In a third aspect, some embodiments of the present disclosure propose an apparatus for performing a proxy reply to an address request packet, applied to a first tunnel endpoint. The apparatus includes:

a first receiving module, configured to receive a first detection packet sent by a second tunnel endpoint;

a first obtaining module, configured to obtain first network addresses carried by the first detection packet, where the first detection packet is generated by the second tunnel endpoint based on the first network addresses stored by the second tunnel endpoint, and the first network addresses are network addresses of one or more first devices corresponding to the second tunnel endpoint; and

a first proxy reply module, configured to, in response to receiving a first address request packet, obtain a first target network address from the first network addresses and send the first target network address to a second device to perform a proxy reply to the first address request packet, where the first target network address is a first network address requested by the first address request packet, and the second device is a device that sends the first address request packet to the first tunnel endpoint.

In some embodiments, the apparatus further includes:

a second generating module, configured to generate a second detection packet based on second network addresses stored by the first tunnel endpoint, where the second network addresses are network addresses of one or more third devices corresponding to the first tunnel endpoint; and

a second sending module, configured to send the second detection packet to the second tunnel endpoint, where the second detection packet is configured for the second tunnel endpoint to obtain the second network addresses carried by the second detection packet, and in response to receiving a second address request packet, obtain a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint.

In some embodiments, a static tunnel is established between the first tunnel endpoint and the second tunnel endpoint, and the apparatus further includes:

a second obtaining module, configured to obtain a tunnel name and a tunnel identifier of the static tunnel;

where the second generating module is specifically configured to:

generate the second detection packet based on the second network addresses stored by the first tunnel endpoint, the tunnel name, and the tunnel identifier;

the second sending module is specifically configured to:

determine a first target tunnel from a plurality of static tunnels corresponding to the first tunnel endpoint based on the tunnel name and the tunnel identifier; and

send the second detection packet to the second tunnel endpoint through the first target tunnel.

In some embodiments, the apparatus further includes:

a first session module, configured to, before the second generating module generates the second detection packet based on the second network addresses stored by the first tunnel endpoint, the tunnel name, and the tunnel identifier, establish a session between the first tunnel endpoint and the second tunnel endpoint based on the tunnel name and the tunnel identifier;

where the second sending module is specifically configured to:

send the second detection packet to the second tunnel endpoint through the first target tunnel under a condition that the session is in a hold state.

In some embodiments, the apparatus further includes:

a first storage module, configured to store the first network addresses in a first database after the first obtaining module obtains the first network addresses carried by the first detection packet;

where the first proxy reply module is specifically configured to:

obtain the first target network address from the first network addresses stored in the first database and send the first target network address to the second device.

In some embodiments, the apparatus further includes:

a first update module, configured to, in response to receiving a third detection packet sent by the second tunnel endpoint, update the first network addresses stored in the first database based on latest first network addresses carried by the third detection packet to obtain an updated first database, where the third detection packet is generated by the second tunnel endpoint based on the latest first network addresses;

where the first proxy reply module is specifically configured to obtain the first target network address from the first network addresses stored in the updated first database.

In some embodiments, the apparatus further includes:

a first timing module, configured to, after the first update module updates the first network addresses stored in the first database based on the latest first network addresses carried by the third detection packet to obtain the updated first database, set a preset first timing parameter to zero, and control the first timing parameter to restart timing, where the first timing parameter is configured to characterize an unupdated duration of the first database; and

a first deletion module, configured to delete the first network addresses stored in the first database in response to the first timing parameter being greater than a preset duration threshold.

In some embodiments, the first proxy reply module is specifically configured to:

determine a first address identifier based on the first address request packet; and

obtain a first network address corresponding to the first address identifier from the first network addresses stored in the first database based on the first address identifier, and determining the first network address as the first target network address.

In a fourth aspect, some embodiments of the present disclosure propose an apparatus for performing a proxy reply to an address request packet, applied to a second tunnel endpoint. The apparatus includes:

a first generating module, configured to generate a first detection packet based on first network addresses stored by the second tunnel endpoint, where the first network addresses are network addresses of one or more first devices corresponding to the second tunnel endpoint; and

a first sending module, configured to send the first detection packet to a first tunnel endpoint, where the first detection packet is configured for the first tunnel endpoint to obtain the first network addresses, and in response to receiving a first address request packet, obtain a first target network address from the first network addresses and send the first target network address to a second device to perform a proxy reply to the first address request packet, where the first target network address is a first network address requested by the first address request packet, and the second device is a device that sends the first address request packet to the first tunnel endpoint.

In some embodiments, the apparatus further includes:

a second receiving module, configured to receive a second detection packet sent by the first tunnel endpoint;

a third obtaining module, configured to obtain second network addresses carried by the second detection packet, where the second detection packet is generated by the first tunnel endpoint based on the second network addresses stored by first tunnel endpoint, and the second network addresses are network addresses of one or more third devices corresponding to the first tunnel endpoint; and

a second proxy reply module, configured to, in response to receiving a second address request packet, obtaining a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint.

In some embodiments, a static tunnel is established between the first tunnel endpoint and the second tunnel endpoint, and the apparatus further includes:

a fourth obtaining module, configured to obtain a tunnel name and a tunnel identifier of the static tunnel;

where the first generating module is specifically configured to:

generate the first detection packet based on the first network addresses stored by the second tunnel endpoint, the tunnel name, and the tunnel identifier;

the first sending module is specifically configured to:

determine a second target tunnel from a plurality of static tunnels corresponding to the second tunnel endpoint based on the tunnel name and the tunnel identifier; and

send the first detection packet to the first tunnel endpoint through the second target tunnel.

In some embodiments, the apparatus further includes:

a second session module, configured to, before the first generating module generates the first detection packet based on the first network addresses stored by the second tunnel endpoint, the tunnel name, and the tunnel identifier, establish a session between the first tunnel endpoint and the second tunnel endpoint based on the tunnel name and the tunnel identifier;

where the first sending module is specifically configured to:

send the first detection packet to the first tunnel endpoint through the second target tunnel under a condition that the session is in a hold state.

In some embodiments, after obtaining the second network addresses carried by the second detection packet, the apparatus further includes:

a second storage module, configured to store the second network addresses in a second database;

where the second proxy reply module is specifically configured to:

obtain the second target network address from the second network addresses stored in the second database and send the second target network address to the fourth device.

In some embodiments, the apparatus further includes:

a second update module, configured to, in response to receiving a fourth detection packet sent by the first tunnel endpoint, update the second network addresses stored in the second database based on latest second network addresses carried by the fourth detection packet to obtain an updated second database, where the fourth detection packet is generated by the first tunnel endpoint based on the latest second network addresses;

where the second proxy reply module is specifically configured to:

obtain the second target network address from the second network addresses stored in the updated second database.

In some embodiments, after updating the second network addresses stored in the second database based on the latest second network addresses carried by the fourth detection packet to obtain the updated second database, the apparatus further includes:

a second timing module, configured to set a preset second timing parameter to zero, and control the second timing parameter to restart timing, where the second timing parameter is configured to characterize an unupdated duration of the second database; and

a second deletion module, configured to delete the second network addresses stored in the second database in response to the second timing parameter being greater than a preset duration threshold.

In some embodiments, the second proxy reply module is specifically configured to:

determine a second address identifier based on the second address request packet; and

obtain a second network address corresponding to the second address identifier from the second network addresses stored in the second database based on the second address identifier, and determine the second network address as the second target network address.

In a first aspect, some embodiments of the present disclosure provide an electronic device, including a processor, a memory, and a computer program stored on the memory and running on the processor. The computer program, when executed by the processor, causes the electronic device to perform the method for performing a proxy reply to an address request packet as described in the first or second aspect.

In a sixth aspect, some embodiments of the present disclosure provide a non-transitory readable storage medium, instructions in the non-transitory readable storage medium, when executed by a processor of an electronic device, cause the electronic device to perform the method for performing a proxy reply to an address request packet in the first or second aspect.

In some embodiments of the present disclosure, since the first detection packet is generated by the second tunnel endpoint based on the stored first network addresses, and the first network addresses are the network addresses of the one or more first devices corresponding to the second tunnel endpoint, the first detection packet carries the network addresses of the one or more first devices corresponding to the second tunnel endpoint. When the first tunnel endpoint receives the first detection packet sent by the second tunnel endpoint and obtains the first network addresses carried by the first detection packet, the first tunnel endpoint obtains the network addresses of the one or more first devices corresponding to the second tunnel endpoint. In the case where the second device sends the first address request packet to the first tunnel endpoint and needs to request the network address of a first device corresponding to the second tunnel endpoint, the first tunnel endpoint might directly obtain the requested first target network address from the first network addresses and send the first target network address to the second device, so that the first tunnel endpoint might perform a proxy reply to the first address request packet. In this way, the first tunnel endpoint might directly respond to the first address request packet based on the obtained first network addresses, avoiding the problem of packet flooding caused by VTEP broadcasting packets in related art, reducing the occupied network resources to a certain extent and improving the network performance.

### BRIEF DESCRIPTION OF THE DRAWINGS

In order to more clearly illustrate the technical solution in some embodiments of the present disclosure or related technologies, the accompanying drawings required for the description of some embodiments or related technologies will be briefly introduced below. Obviously, the drawings described below are only some examples of the present disclosure, and other drawings can be obtained according to these drawings without creative labor for those skilled in the art.

FIG. 1 is a flowchart of a method for performing a proxy reply to an address request packet provided by some embodiments of the present disclosure.

FIG. 2 is a flowchart of another method for performing a proxy reply to an address request packet provided by some embodiments of the present disclosure.

FIG. 3 is a schematic diagram of address resolution protocol (ARP) request packet suppression in the related art.

FIG. 4 is a schematic diagram of ARP broadcast suppression in the related art.

FIG. 5 is a schematic diagram of an ARP proxy reply in the related art.

FIG. 6 is a schematic diagram of bidirectional forwarding detection (BFD) remote medium access control (MAC) address publishing provided by some embodiments of the present disclosure.

FIG. 7 is a schematic architectural diagram of service devices provided by some embodiments of the present disclosure.

FIG. 8 is a schematic diagram of a service control flow provided by some embodiments of the present disclosure.

FIG. 9 is a schematic diagram of a BFD keep alive packet carrying a remote MAC address provided by some embodiments of the present disclosure.

FIG. 10 is a schematic diagram of a control flow of a BFD remote MAC address provided in some embodiments of the present disclosure.

FIG. 11 is a structural diagram of an apparatus for performing a proxy reply to an address request packet provided by some embodiments of the present disclosure.

FIG. 12 is a structural diagram of another apparatus for performing a proxy reply to an address request packet provided by some embodiments of the present disclosure.

FIG. 13 is a schematic diagram of an electronic device provided in some embodiments of the present disclosure.

### DETAILED DESCRIPTION

The technical solution in some embodiments of the present disclosure will be clearly and completely described as below with reference to the accompanying drawings in some embodiments of the present disclosure. Obviously, the described embodiments are only a part of the embodiments of the present disclosure, but not all of them. Based on some embodiments in the present disclosure, all other embodiments obtained by those skilled in the art without creative labor are within the protection scope of the present disclosure.

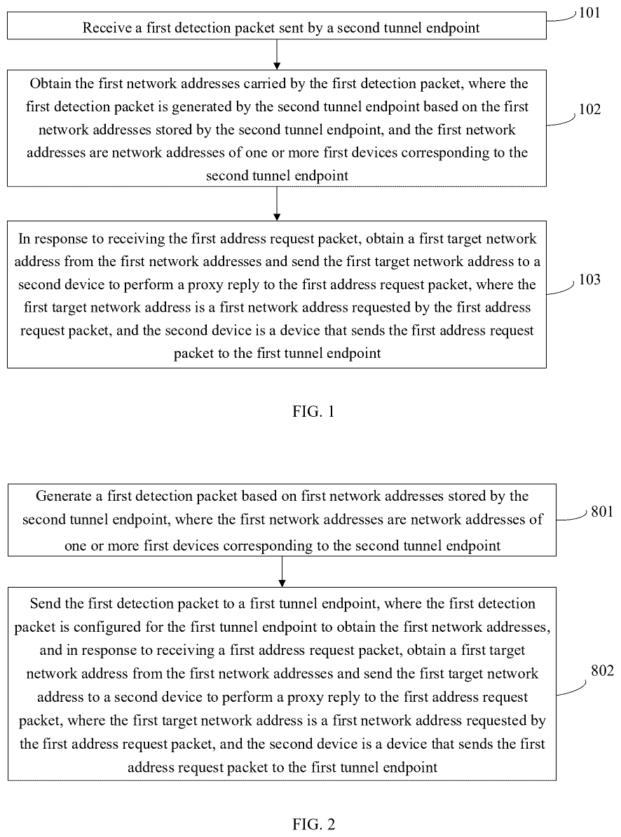

FIG. 1 is a flowchart of a method for performing a proxy reply to an address request packet provided by some embodiments of the present disclosure. As shown in FIG. 1, the method is applied to a first tunnel endpoint and includes steps 101 to 103.

In step 101, a first detection packet sent by a second tunnel endpoint is received.

In some embodiments of the present disclosure, the first tunnel endpoint and the second tunnel endpoint may be virtual tunnel endpoints (VTEPs) of a Virtual extensible Local Area Network (VXLAN). The first tunnel endpoint and the second tunnel endpoint may be connected through a tunnel. The tunnel is a virtual channel, and the two VXLAN communication parties, namely the first tunnel endpoint and the second tunnel endpoint, consider themselves to be in direct communication and are unaware of the existence of an underlying network.

In some embodiments of the present disclosure, the first detection packet may be a packet for detecting failures in a bidirectional forwarding path between the first tunnel endpoint and the second tunnel endpoint. For example, a bidirectional forwarding detection (BFD) packet in BFD technology. In some embodiments of the present disclosure, the first detection packet carries first network addresses stored by the second tunnel endpoint in addition to contents related to bidirectional forwarding path failure detection. The first network address are network addresses of one or more local devices learned by the second tunnel endpoint. The network addresses may include Internet protocol (IP) addresses and media access control (MAC) addresses.

It should be noted that the BFD is a unified detection mechanism, which is used to quickly detect and monitor the forwarding connectivity of links or IP routes in a network. The BFD can establish a session between two network devices to detect the bidirectional forwarding path between the network devices. After the session is established, one network device can send BFD packets periodically and quickly. If no BFD packet replied by the peer network device is received within detection time, it is considered that the bidirectional forwarding path between the two network devices has failed, and a served upper-layer application can be notified to handle the corresponding failure.

In step 102, the first network addresses carried by the first detection packet are obtained, where the first detection packet is generated by the second tunnel endpoint based on the first network addresses stored by the second tunnel endpoint, and the first network addresses are network addresses of one or more first devices corresponding to the second tunnel endpoint.

In some embodiments of the present disclosure, the one or more first devices corresponding to the second tunnel endpoint may be devices connected to the second tunnel endpoint. There may be one or more first devices, which is not limited in some embodiments of the present disclosure. The second tunnel endpoint can learn the network addresses of the one or more connected first devices. Specifically, the second tunnel endpoint may obtain and store IP addresses and MAC addresses of the one or more first devices.

In some embodiments of the present disclosure, when generating the first detection packet, the second tunnel endpoint may add first network addresses of respective first devices corresponding to the second tunnel endpoint to a field corresponding to an optional content according to a packet format, so that the first detection packet carries the first network addresses of respective first devices. For example, if the first detection packet is a BFD packet, the first network addresses can be added to an optional content field after 48 bytes, so that the BFD packet carries the first network addresses. This is only an example, and some embodiments of the present disclosure do not limit this.

In some embodiments of the present disclosure, when receiving the first detection packet, the first tunnel endpoint can perform a unpacking operation to obtain the first network addresses from the first detection packet, and store the first network addresses in a designated location, for example, in a first database, so that the first network addresses may be queried and obtained from the first database when a first address request packet is received.

In step 103, in response to receiving the first address request packet, a first target network address is obtained from the first network addresses and the first target network address is sent to a second device to perform a proxy reply to the first address request packet, where the first target network address is a first network address requested by the first address request packet, and the second device is a device that sends the first address request packet to the first tunnel endpoint.

In some embodiments of the present disclosure, the second device may be one of devices connected to the first tunnel endpoint. The second device generates the first address request packet based on a known IP address of a target device to be accessed and a MAC address of the requested target device, and sends the first address request packet to the first tunnel endpoint. The target device may be any first device corresponding to the second tunnel endpoint.

In some embodiments of the present disclosure, the first network address requested by the first address request packet may be the MAC address of the target device, and the target device may be any first device corresponding to the second tunnel endpoint. That is, the first target network address may be the MAC address of any first device corresponding to the second tunnel endpoint.

In some embodiments of the present disclosure, upon receiving the first address request packet, the first tunnel endpoint can determine the IP address of the target device requested by the second device based on the first address request packet, search and obtain the MAC address of the target device corresponding to the IP address of the target device from the stored first network addresses based on the IP address of the target device, and use the MAC address of the target device as the first target network address. And the first tunnel endpoint sends the first target network address which is the MAC address of the target device to the second device, so that the first tunnel endpoint may perform a proxy reply to the first address request packet, that is, reply the first target network address requested by the second device.

For example, the first address request packet may be an address resolution protocol (ARP) request packet. Upon receiving the ARP request packet, based on the IP address of the target device requested by the ARP request packet, the first tunnel endpoint can obtain the MAC address of the target device corresponding to the IP address of the target device from the stored first network addresses, and reply to the second device as the first target network address, thereby performing a proxy reply to the ARP request packet. The target device may be any first device corresponding to the second tunnel endpoint.

Compared with operations of a VTEP broadcasting the ARP request packet and obtaining the network address of the target device from the VXLAN network through broadcasting when receiving the ARP request packet in related art, the method for performing a proxy reply to an address request packet in some embodiments of the present disclosure might avoid the first tunnel endpoint broadcasting the first address request packet. The first tunnel endpoint might directly reply the address requested by the first address request packet based on the obtained first network addresses, which might avoid the problem of packet flooding, further reduce occupied network resources, and improve network performance.

In some embodiments of the present disclosure, since the first detection packet is generated by the second tunnel endpoint based on the stored first network addresses, and the first network addresses are the network addresses of the one or more first devices corresponding to the second tunnel endpoint, the first detection packet carries the network addresses of the one or more first devices corresponding to the second tunnel endpoint. When the first tunnel endpoint receives the first detection packet sent by the second tunnel endpoint and obtains the first network addresses carried by the first detection packet, the first tunnel endpoint obtains the network addresses of the one or more first devices corresponding to the second tunnel endpoint. In the case where the second device sends the first address request packet to the first tunnel endpoint and needs to request the network address of a first device corresponding to the second tunnel endpoint, the first tunnel endpoint may directly obtain the requested first target network address from the first network addresses and send the first target network address to the second device, so that the first tunnel endpoint may perform a proxy reply to the first address request packet. In this way, the first tunnel endpoint may directly respond to the first address request packet based on the obtained first network addresses, avoiding the problem of packet flooding caused by VTEP broadcasting packets in related art, reducing the occupied network resources to a certain extent and improving the network performance.

In some embodiments, the method further includes steps 201 and 202.

In step 201, a second detection packet is generated based on second network addresses stored by the first tunnel endpoint, where the second network addresses are network addresses of one or more third devices corresponding to the first tunnel endpoint.

In some embodiments of the present disclosure, the one or more third devices corresponding to the first tunnel endpoint may be devices connected to the first tunnel endpoint. There may be one or more third devices, which is not limited in some embodiments of the present disclosure. The first tunnel endpoint can learn the network addresses of the one or more connected third devices. Specifically, the first tunnel endpoint can obtain and store IP addresses and MAC addresses of the one or more third devices.

In some embodiments of the present disclosure, the first tunnel endpoint may add second network addresses of respective third devices corresponding to the first tunnel endpoint to a field corresponding to an optional content of the second detection packet according to a packet format of the detection packet, and then determine the detection packet with the added second network addresses as the second detection packet, so that the second detection packet carries the second network addresses of respective third devices. For example, if the second detection packet is a BFD packet, the second network addresses can be added to an optional content field after 48 bytes of the BFD packet, so that the BFD packet carries the second network addresses. This is only an example, and some embodiments of the present disclosure do not limit this.

In step 202, the second detection packet is sent to the second tunnel endpoint, where the second detection packet is configured for the second tunnel endpoint to obtain the second network addresses carried by the second detection packet, and in response to receiving a second address request packet, obtain a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint In some embodiments of the present disclosure, the first tunnel endpoint may send the second detection packet to the second tunnel endpoint through a tunnel connected to the second tunnel endpoint. When receiving the second detection packet, the second tunnel endpoint can perform a unpacking operation to obtain the second network addresses from the second detection packet, and store the second network addresses in a designated location, for example, in a second database, so that the second network addresses may be queried and obtained from the second database when the second address request packet is received.

In some embodiments of the present disclosure, the fourth device may be one of devices connected to the second tunnel endpoint. The fourth device generates the second address request packet based on a known IP address of a target device to be accessed and a MAC address of the requested target device, and sends the second address request packet to the second tunnel endpoint. The target device may be any third device corresponding to the first tunnel endpoint.

In some embodiments of the present disclosure, the second network address requested by the second address request packet may be the MAC address of the target device, and the target device may be any third device corresponding to the first tunnel endpoint. That is, the second target network address may be the MAC address of any third device corresponding to the first tunnel endpoint.

In some embodiments of the present disclosure, upon receiving the second address request packet, the second tunnel endpoint can determine the IP address of the target device requested by the fourth device based on the second address request packet, obtain the MAC address of the target device corresponding to the IP address of the target device from the stored second network addresses based on the IP address of the target device as the second target network address. And the second tunnel endpoint sends the second target network address which is the MAC address of the target device to the fourth device, so that the second tunnel endpoint may perform a proxy reply to the second address request packet, that is, reply the second target network address requested by the fourth device.

In some embodiments of the present disclosure, since the second detection packet is generated by the first tunnel endpoint based on the stored second network addresses, and the second network addresses are the network addresses of the one or more third devices corresponding to the first tunnel endpoint, the second detection packet carries the network addresses of the one or more third devices corresponding to the first tunnel endpoint. The first tunnel endpoint sends the second detection packet to the second tunnel endpoint, so that the second tunnel endpoint receives and obtains the second network addresses carried by the second detection packet. Therefore, the second tunnel endpoint obtains the network addresses of the one or more third devices corresponding to the first tunnel endpoint. In the case where the fourth device sends the second address request packet to the second tunnel endpoint and needs to request the network address of a third device corresponding to the first tunnel endpoint, the second tunnel endpoint might directly obtain the requested second target network address from the second network addresses and send the second target network address to the fourth device, so that the second tunnel endpoint might perform a proxy reply to the second address request packet. In this way, the second tunnel endpoint might directly respond to the second address request packet based on the obtained second network addresses, avoiding the problem of packet flooding caused by VTEP broadcasting packets in related art, reducing the occupied network resources to a certain extent and improving the network performance.

In some embodiments, a static tunnel is established between the first tunnel endpoint and the second tunnel endpoint, and the method further include step 301.

In step 301, a tunnel name and a tunnel identifier of the static tunnel are obtained.

In some embodiments, step 201 includes step 2011.

In step 2011, the second detection packet is generated based on the second network addresses stored by the first tunnel endpoint, the tunnel name, and the tunnel identifier.

In some embodiments, step 202 includes steps 2022 and 2023.

In step 2022, a first target tunnel is determined from a plurality of static tunnels corresponding to the first tunnel endpoint based on the tunnel name and the tunnel identifier.

In step 2023, the second detection packet is sent to the second tunnel endpoint through the first target tunnel.

In some embodiments of the present disclosure, the static tunnel is established between the first tunnel endpoint and the second tunnel endpoint. Specifically, a static route can be configured and virtual local area network (VLAN) related settings can be made between the first tunnel endpoint and the second tunnel endpoint, and a VXLAN static tunnel interface instance can be created to establish the static tunnel between the first tunnel endpoint and the second tunnel endpoint. The specific configuration method and creation method can refer to the descriptions in the related art, and some embodiments of the present disclosure do not limit this.

In some embodiments of the present disclosure, the first tunnel endpoint may obtain the tunnel name and the tunnel identifier of the VXLAN static tunnel from the upper-layer application of the VXLAN network. The tunnel identifier may be a VXLAN network identifier (VNI). The first tunnel endpoint can add the second network addresses of respective third devices corresponding to the first tunnel endpoint, as well as the obtained tunnel name and tunnel identifier, to the field corresponding to the optional content of the second detection packet according to the packet format of the detection packet. Then, the added detection packet is determined as the second detection packet, so that the second detection packet carries the second network addresses of respective third devices, as well as the tunnel name and the tunnel identifier of the VXLAN static tunnel. The tunnel name and the tunnel identifier of the VXLAN static tunnel can be used by the second tunnel endpoint to perform tunnel identification based on the tunnel name and the tunnel identifier after receiving the second detection packet, so as to determine the target tunnel connected to the first tunnel endpoint.

In some embodiments of the present disclosure, the first tunnel endpoint may be connected to a plurality of static tunnels. The first tunnel endpoint may perform identification based on the tunnel name and the tunnel identifier of the static tunnel connected to the second tunnel endpoint, and determine the static tunnel connected to the second tunnel endpoint from the plurality of static tunnels as the first target tunnel. Specifically, the static route corresponding to the static tunnel connected by the first tunnel endpoint and the second tunnel endpoint can be configured based on the tunnel name and the tunnel identifier, that is, the tunnel name and the tunnel identifier are configured as a next hop of the static route, thereby determining the static tunnel connected by the first tunnel endpoint and the second tunnel endpoint as the first target tunnel.

In some embodiments of the present disclosure, the tunnel name and the tunnel identifier of the static tunnel are obtained; the second detection packet is generated based on the second network addresses stored by the first tunnel endpoint, the tunnel name, and the tunnel identifier; the first target tunnel is determined from the plurality of static tunnels corresponding to the first tunnel endpoint based on the tunnel name and the tunnel identifier; the second detection packet is sent to the second tunnel endpoint through the first target tunnel. In this way, the first tunnel endpoint might conveniently identify the static tunnel connected to the second tunnel endpoint based on the tunnel name and the tunnel identifier to determine the first target tunnel, so as to conveniently send the second detection packet to the second tunnel endpoint through the first target tunnel. So that the second tunnel endpoint can receive the second detection packet, which might improve the practicality of the method for performing a proxy reply to an address request packet in the embodiments of the present disclosure to a certain extent.

In some embodiments, before step 2011, the method further includes step 401.

In step 401, a session is established between the first tunnel endpoint and the second tunnel endpoint based on the tunnel name and the tunnel identifier.

Step 2023 may include step 2023a.

In step 2023a, the second detection packet is sent to the second tunnel endpoint through the first target tunnel under a condition that the session is in a hold state.

In some embodiments of the present disclosure, the first tunnel endpoint may generate a session negotiation packet based on the tunnel name, the tunnel identifier, and an identifier of the first tunnel endpoint, and send the session negotiation packet to the second tunnel endpoint. After receiving the session negotiation packet, the second tunnel endpoint may obtain the tunnel name and the tunnel identifier carried by the session negotiation packet, and match them with tunnel names and tunnel identifiers stored locally by the second tunnel endpoint. If the tunnel name and tunnel identifier are consistent, the matching is successful, and the second tunnel endpoint learns the identifier of the first tunnel endpoint, thereby establishing a session with the first tunnel endpoint.

In some embodiments of the present disclosure, when a session is established between the first tunnel endpoint and the second tunnel endpoint, it can be determined that bidirectional communication is normal by periodically sending packets. If both parties can receive the packet sent by the peer, the session is in a hold state. If either party cannot receive the packet sent by the peer, the session is in a disconnected state.

In some embodiments of the present disclosure, when the session established between the first tunnel endpoint and the second tunnel endpoint is in the hold state, it indicates that the bidirectional communication between the first tunnel endpoint and the second tunnel endpoint is normal. The first tunnel endpoint sends the second detection packet to the second tunnel endpoint through the first target tunnel, so that the second tunnel endpoint can receive the second detection packet, which might improve a success rate of sending the second detection packet to a certain extent. Further, the second tunnel endpoint can obtain the second network addresses from the second detection packet, thereby performing a proxy reply to the second address request packet sent to the second tunnel endpoint, which might improve a proxy reply success rate of the method for performing a proxy reply to an address request packet in some embodiments of the present disclosure.

In some embodiments of the present disclosure, the session is established between the first tunnel endpoint and the second tunnel endpoint based on the tunnel name and the tunnel identifier; the second detection packet is sent to the second tunnel endpoint through the first target tunnel under the condition that the session is in the hold state. In this way, through the session state between the first tunnel endpoint and the second tunnel endpoint, it can be determined that the communication between the first tunnel endpoint and the second tunnel endpoint is normal when the session is in the hold state, so that the second tunnel endpoint can receive the second detection packet sent by the first tunnel endpoint, which might improve the success rate of sending the second detection packet to a certain extent.

In some embodiments, after obtaining the first network addresses carried by the first detection packet, the method further includes step 501.

In step 501, the first network addresses are stored in the first database.

Step 103 may include step 1031.

In step 1031, the first target network address is obtained from the first network addresses stored in the first database and the first target network address is sent to the second device.

In some embodiments of the present disclosure, the first database may be a database connected to the first tunnel endpoint. The first database may be a local database or a network database, which is not limited in some embodiments of the present disclosure. After obtaining the first network addresses, the first tunnel endpoint can store the first network addresses in the first database. Specifically, the first network addresses can include IP addresses and MAC addresses of the one or more first devices corresponding to the second tunnel endpoint. The IP addresses and the MAC addresses of the one or more first devices can be stored in the first database correspondingly.

When receiving the first address request packet, the first tunnel endpoint can query for the MAC address corresponding to the IP address from the first database based on the IP address of the target device requested in the first address request packet, and use the MAC address as the first target network address. The first tunnel endpoint sends the first target network address which is the MAC address to the second device, so as to reply with the MAC address of the target device requested by the second device.

In some embodiments of the present disclosure, the first network addresses are stored in the first database, which is convenient for the first tunnel endpoint to directly obtain the first target network address from the first network addresses stored in the first database upon receiving the first address request. This might improve the efficiency of obtaining the first target network address. And the first tunnel endpoint sends the first target network address to the second device, which might improve a proxy reply efficiency of the method for performing a proxy reply to an address request packet in some embodiments of the present disclosure to some extent.

In some embodiments, the method further includes step 601.

In step 601, in response to receiving a third detection packet sent by the second tunnel endpoint, the first network addresses stored in the first database are updated based on latest first network addresses carried by the third detection packet to obtain an updated first database, where the third detection packet is generated by the second tunnel endpoint based on the latest first network addresses.

Step 1031 may include step 1031a.

In step 1031a, the first target network address is obtained from the first network addresses stored in the updated first database.

In some embodiments of the present disclosure, in the case where a session is established between the first tunnel endpoint and the second tunnel endpoint, the first tunnel endpoint and the second tunnel endpoint can determine that the bidirectional forwarding path between the first tunnel endpoint and the second tunnel endpoint is normal by periodically sending detection packets to the peer. During the process of periodically sending detection packets to the first tunnel endpoint, the second tunnel endpoint can continuously learn network addresses of one or more first devices connected to the second tunnel, and obtain latest network addresses of respective first devices as the latest first network addresses. When the second tunnel endpoint learns the latest first network addresses, the second tunnel endpoint can generate the third detection packet based on the latest first network addresses and send the third detection packet to the first tunnel endpoint. Specifically, the latest first network addresses can be added to the field corresponding to the optional content based on the packet format of the detection packet, and the added detection packet can be used as the third detection packet.

In some embodiments of the present disclosure, upon receiving the third detection packet sent by the second tunnel endpoint, the first tunnel endpoint may perform a unpacking operation to obtain the latest first network addresses carried by the third detection packet. Then, the first network addresses stored in the first database are updated to the latest first network addresses, and the first database with the updated first network addresses can be used as the updated first database. When receiving the first address request, the first tunnel endpoint can obtain the first target network address from the first network addresses stored in the updated first database, so that the first target network address is the latest first network address. Further, the first tunnel endpoint sends the first target network address to the second device, which might improve a proxy reply accuracy of the method for performing a proxy reply to an address request packet in some embodiments of the present disclosure.

In some embodiments of the present disclosure, upon receiving the third detection packet sent by the second tunnel endpoint, the first network addresses stored in the first database are updated based on the latest first network addresses carried by the third detection packet, so as to obtain the updated first database. Since the third detection packet is generated by the second tunnel endpoint based on the latest first network addresses, the first tunnel endpoint can update the first network addresses stored in the first database to the latest first network addresses, so that the first network addresses stored in the updated first database are the latest first network addresses, and the updated first database is more accurate. Further, the first tunnel endpoint obtains the first target network address from the first network addresses stored in the updated first database, so that the first target network address is the latest first network address, which improves the accuracy of the first target network address to a certain extent.

In some embodiments, after step 601, the method further includes steps 701 and 702.

In step 701, a preset first timing parameter is set to zero, and the first timing parameter is controlled to restart timing, where the first timing parameter is configured to characterize an unupdated duration of the first database.

In step 702, the first network addresses stored in the first database are deleted in response to the first timing parameter being greater than a preset duration threshold.

In some embodiments of the present disclosure, the unupdated duration of the first database can be counted through the first timing parameter. After the first timing parameter is set to zero and the timing is restarted, the unupdated duration of the first database can be automatically recorded. The unupdated duration of the first database represents the duration that the first network addresses stored in the first database have not been updated.

In some embodiments of the present disclosure, after updating the first network addresses stored in the first database, the first tunnel endpoint can set the first timing parameter to zero, for example, assign the first timing parameter to zero, and control the first timing parameter to restart timing, so that the first timing parameter may automatically record the unupdated duration of the first database.

In some embodiments of the present disclosure, the preset duration threshold can represent a maximum unupdated duration allowed for the first database, and the preset duration threshold can be set according to the actual application scenario, which is not limited in some embodiments of the present disclosure. When the first timing parameter is greater than the preset duration threshold, it indicates that the first network addresses stored in the first database have expired, and the first network addresses stored in the first database can be deleted, so as to reduce the resource occupation of the first database by the expired first network addresses and improve the resource utilization of the first database.

In some embodiments of the present disclosure, the preset first timing parameter is set to zero and the first timing parameter is controlled to restart timing; the first network addresses stored in the first database are deleted when the first timing parameter is greater than the preset duration threshold. Since the first timing parameter is used to represent the unupdated duration of the first database, when the first timing parameter is greater than the preset duration threshold, it indicates that the unupdated duration of the first database has exceeded the preset duration threshold, and the first network addresses stored in the first database have timed out and not been updated. Further, by deleting the first network addresses stored in the first database, the resource occupation of the first database by the first network addresses that have timed out and not been updated might be reduced, which might improve the resource utilization of the first database to some extent.

In some embodiments, step 1031 may include steps 1031b and 1031c.

In step 1031b, a first address identifier is determined based on the first address request packet.

In step 1031c, a first network address corresponding to the first address identifier is obtained from the first network addresses stored in the first database based on the first address identifier, and the first network address is determined as the first target network address.

In some embodiments of the present disclosure, the first address request packet may be generated by the second device based on the known IP address of the target device to be accessed and the MAC address of the requested target device. The first address identifier may be the IP address of the target device in the first address request packet.

In some embodiments of the present disclosure, the first tunnel endpoint may perform a unpacking operation on the first address request packet to obtain the IP address of the target device in the first address request packet as the first address identifier. The first tunnel endpoint can search for the MAC address of the target device corresponding to the IP address of the target device from the first database based on the IP address of the target device, and determine the found MAC address of the target device, i.e., the first network address corresponding to the first address identifier, as the first target network address.

In some embodiments of the present disclosure, the first address identifier is determined based on the first address request packet; the first network address corresponding to the first address identifier is obtained from the first network addresses stored in the first database based on the first address identifier, and the first network address is determined as the first target network address. In this way, since the first address identifier is determined based on the first address request packet, the first address identifier matches the first network address requested by the first address request packet. Further, based on the first address identifier, the first target network address might be conveniently determined from the first database, which might improve the efficiency of obtaining the first target network address to a certain extent.

FIG. 2 is a flowchart of another method for performing a proxy reply to an address request packet provided by some embodiments of the present disclosure. As shown in FIG. 2, the method is applied to a second tunnel endpoint and includes steps 801 and 802.

In step 801, a first detection packet is generated based on first network addresses stored by the second tunnel endpoint, where the first network addresses are network addresses of one or more first devices corresponding to the second tunnel endpoint.

In step 802, the first detection packet is sent to a first tunnel endpoint, where the first detection packet is configured for the first tunnel endpoint to obtain the first network addresses, and in response to receiving a first address request packet, obtain a first target network address from the first network addresses and send the first target network address to a second device to perform a proxy reply to the first address request packet, where the first target network address is a first network address requested by the first address request packet, and the second device is a device that sends the first address request packet to the first tunnel endpoint.

In some embodiments of the present disclosure, the one or more first devices corresponding to the second tunnel endpoint may be devices connected to the second tunnel endpoint. There may be one or more first devices, which is not limited in some embodiments of the present disclosure. The second tunnel endpoint can learn the network addresses of the one or more connected first devices. Specifically, the second tunnel endpoint may obtain and store IP addresses and MAC addresses of the one or more first devices.

In some embodiments of the present disclosure, when generating the first detection packet, the second tunnel endpoint may add first network addresses of respective first devices corresponding to the second tunnel endpoint to a field corresponding to an optional content according to a packet format, so that the first detection packet carries the first network addresses of respective first devices.

In some embodiments of the present disclosure, the steps performed by the first tunnel endpoint can refer to the relevant descriptions of steps 101-103, which will not be repeated here.

In some embodiments of the present disclosure, since the first detection packet is generated by the second tunnel endpoint based on the stored first network addresses, and the first network addresses are the network addresses of the one or more first devices corresponding to the second tunnel endpoint, the first detection packet carries the network addresses of the one or more first devices corresponding to the second tunnel endpoint. When the first tunnel endpoint receives the first detection packet sent by the second tunnel endpoint and obtains the first network addresses carried by the first detection packet, the first tunnel endpoint obtains the network addresses of the one or more first devices corresponding to the second tunnel endpoint. In the case where the second device sends the first address request packet to the first tunnel endpoint and needs to request the network address of a first device corresponding to the second tunnel endpoint, the first tunnel endpoint might directly obtain the requested first target network address from the first network addresses and send the first target network address to the second device, so that the first tunnel endpoint might perform a proxy reply to the first address request packet. In this way, the first tunnel endpoint might directly respond to the first address request packet based on the obtained first network addresses, avoiding the problem of packet flooding caused by VTEP broadcasting packets in related art, reducing occupied network resources to a certain extent and improving the network performance.

In some embodiments, the method further includes steps 901 to 903.

In step 901, a second detection packet sent by the first tunnel endpoint is received.

In step 902, second network addresses carried by the second detection packet are obtained, where the second detection packet is generated by the first tunnel endpoint based on the second network addresses stored by first tunnel endpoint, and the second network addresses are network addresses of one or more third devices corresponding to the first tunnel endpoint.

In step 903, in response to receiving a second address request packet, a second target network address is obtained from the second network addresses and the second target network address is sent to a fourth device to perform a proxy reply to the second address request packet, where the second target network address is a second network address requested by the second address request packet, and the fourth device is a device that sends the second address request packet to the second tunnel endpoint.

In some embodiments of the present disclosure, when receiving the second detection packet, the second tunnel endpoint can perform a unpacking operation to obtain the second network addresses from the second detection packet, and store the second network addresses in a designated location, for example, in a second database, so that the second network addresses can be queried and obtained from the second database when the second address request packet is received.

In some embodiments of the present disclosure, the fourth device may be one of devices connected to the second tunnel endpoint. The fourth device generates the second address request packet based on a known IP address of a target device to be accessed and a MAC address of the requested target device, and sends the second address request packet to the second tunnel endpoint. The target device may be any third device corresponding to the first tunnel endpoint.

In some embodiments of the present disclosure, the second network address requested by the second address request packet may be the MAC address of the target device, and the target device may be any third device corresponding to the first tunnel endpoint. That is, the second target network address may be the MAC address of any third device corresponding to the first tunnel endpoint.

In some embodiments of the present disclosure, upon receiving the second address request packet, the second tunnel endpoint can determine the IP address of the target device requested by the fourth device based on the second address request packet, obtain the MAC address of the target device corresponding to the IP address of the target device from the stored second network addresses based on the IP address of the target device as the second target network address. And the second tunnel endpoint sends the second target network address which is the MAC address of the target device to the fourth device, so that the second tunnel endpoint can perform a proxy reply to the second address request packet, that is, reply the second target network address requested by the fourth device.

In some embodiments of the present disclosure, since the second detection packet is generated by the first tunnel endpoint based on the stored second network addresses, and the second network addresses are the network addresses of the one or more third devices corresponding to the first tunnel endpoint, the second detection packet carries the network addresses of the one or more third devices corresponding to the first tunnel endpoint. The first tunnel endpoint sends the second detection packet to the second tunnel endpoint, so that the second tunnel endpoint receives and obtains the second network addresses carried by the second detection packet. Therefore, the second tunnel endpoint obtains the network addresses of the one or more third devices corresponding to the first tunnel endpoint. In the case where the fourth device sends the second address request packet to the second tunnel endpoint and needs to request the network address of a third device corresponding to the first tunnel endpoint, the second tunnel endpoint might directly obtain the requested second target network address from the second network addresses and send the second target network address to the fourth device, so that the second tunnel endpoint might perform a proxy reply to the second address request packet. In this way, the second tunnel endpoint might directly respond to the second address request packet based on the obtained second network addresses, avoiding the problem of packet flooding caused by VTEP broadcasting packets in related art, reducing the occupied network resources to a certain extent and improving the network performance.

In some embodiments, a static tunnel is established between the first tunnel endpoint and the second tunnel endpoint, and the method further includes step 1001.

In step 1001, a tunnel name and a tunnel identifier of the static tunnel are obtained.

Step 801 may include step 8011.

In step 8011, the first detection packet is generated based on the first network addresses stored by the second tunnel endpoint, the tunnel name, and the tunnel identifier.

Step 802 may include steps 8021 and 8022.

In step 8021, a second target tunnel is determined from a plurality of static tunnels corresponding to the second tunnel endpoint based on the tunnel name and the tunnel identifier.

In step 8022, the first detection packet is sent to the first tunnel endpoint through the second target tunnel.

In some embodiments of the present disclosure, the implementation of step 1001 can refer to the implementation of step 301, which will not be repeated here.

In some embodiments of the present disclosure, the second tunnel endpoint may be connected to a plurality of static tunnels. The second tunnel endpoint may perform identification based on the tunnel name and the tunnel identifier of the static tunnel connected to the second tunnel endpoint, and determine a static tunnel connected to the first tunnel endpoint from the plurality of static tunnels as the second target tunnel. Specifically, a static route corresponding to the static tunnel connected by the first tunnel endpoint and the second tunnel endpoint can be configured based on the tunnel name and the tunnel identifier, that is, the tunnel name and the tunnel identifier are configured as a next hop of the static route, thereby determining the static tunnel connected by the first tunnel endpoint and the second tunnel endpoint as the second target tunnel.

In some embodiments of the present disclosure, the second tunnel endpoint might conveniently identify the static tunnel connected to the second tunnel endpoint based on the tunnel name and the tunnel identifier to determine the second target tunnel, so as to conveniently send the first detection packet to the first tunnel endpoint through the second target tunnel. So that the first tunnel endpoint can receive the first detection packet, which might improve the practicality of the method for performing a proxy reply to an address request packet in some embodiments of the present disclosure to a certain extent.

In some embodiments, before step 8011, the method further includes step 1101.

In step 1101, a session is established between the first tunnel endpoint and the second tunnel endpoint based on the tunnel name and the tunnel identifier.

Step 8022 may include step 8022a.

Step 8022a, the first detection packet is sent to the first tunnel endpoint through the second target tunnel under a condition that the session is in a hold state.

In some embodiments of the present disclosure, the implementation of step 1101 can refer to the implementation of step 401, which will not be repeated here.

In some embodiments of the present disclosure, when the session state established between the first tunnel endpoint and the second tunnel endpoint is in the hold state, it indicates that the bidirectional communication between the first tunnel endpoint and the second tunnel endpoint is normal. The second tunnel endpoint sends the first detection packet to the first tunnel endpoint through the second target tunnel, so that the first tunnel endpoint can receive the first detection packet, which might improve a success rate of sending the first detection packet to a certain extent. Further, the first tunnel endpoint can obtain the first network addresses from the first detection packet, thereby performing a proxy reply to the first address request packet sent to the first tunnel endpoint, which might improve a proxy reply success rate of the method for performing a proxy reply to an address request packet in some embodiments of the present disclosure.

In some embodiments, after obtaining the second network addresses carried by the second detection packet, the method further includes step 1201.

In step 1201, the second network addresses are stored in a second database.

Step 903 may include step 9031.

In step 9031, the second target network address is obtained from the second network addresses stored in the second database and the second target network address is sent to the fourth device.

In some embodiments of the present disclosure, the second database may be a database connected to the second tunnel endpoint. The second database may be a local database or a network database, which is not limited in the embodiments of the present disclosure. After obtaining the second network addresses, the second tunnel endpoint can store the second network addresses in the second database. Specifically, the second network addresses can include IP addresses and MAC addresses of the one or more third devices corresponding to the first tunnel endpoint. The IP addresses and the MAC addresses of the one or more third devices can be stored in the second database correspondingly.

When receiving the second address request packet, the second tunnel endpoint can query for the MAC address corresponding to the IP address from the second database based on the IP address of the target device requested in the second address request packet, and use the MAC address as the second target network address. The first tunnel endpoint sends the second target network address which is the MAC address to the fourth device, so as to reply with the MAC address of the target device requested by the fourth device.

In some embodiments of the present disclosure, the second network address are stored in the second database, which is convenient for the second tunnel endpoint to directly obtain the second target network address from the second network addresses stored in the second database upon receiving the second address request. This might improve the efficiency of obtaining the second target network address. And the second tunnel endpoint sends the second target network address to the fourth device, which might improve a proxy reply efficiency of the method for performing a proxy reply to an address request packet in some embodiments of the present disclosure to some extent.

In some embodiments, the method further includes step 1301.

In step 1301, in response to receiving a fourth detection packet sent by the first tunnel endpoint, the second network addresses stored in the second database are updated based on latest second network addresses carried by the fourth detection packet to obtain an updated second database, where the fourth detection packet is generated by the first tunnel endpoint based on the latest second network addresses.

Step 9031 may include step 9031a.

In step 9031a, the second target network address is obtained from the second network addresses stored in the updated second database.

In some embodiments of the present disclosure, when the first tunnel endpoint learns the latest second network addresses, the first tunnel endpoint can generate the fourth detection packet based on the latest second network addresses and send the fourth detection packet to the second tunnel endpoint. Specifically, the latest second network addresses can be added to a field corresponding to an optional content based on a packet format of the detection packet, and the added detection packet can be used as the fourth detection packet.

In some embodiments of the present disclosure, upon receiving the fourth detection packet sent by the first tunnel endpoint, the second tunnel endpoint may perform a unpacking operation to obtain the latest second network addresses carried by the fourth detection packet. Then, the second network addresses stored in the second database are updated to the latest second network addresses, and the second database with the updated second network addresses can be used as the updated second database. When receiving the second address request, the second tunnel endpoint can obtain the second target network address from the second network addresses stored in the updated second database, so that the second target network address is the latest second network address. Further, the second tunnel endpoint sends the second target network address to the fourth device, which might improve a proxy reply accuracy of the method for performing a proxy reply to an address request packet in some embodiments of the present disclosure.

In some embodiments of the present disclosure, since the fourth detection packet is generated by the first tunnel endpoint based on the latest second network addresses, the second tunnel endpoint can update the second network addresses stored in the second database to the latest second network addresses, so that the second network addresses stored in the updated second database are the latest second network addresses, and the updated second database is more accurate. Further, the second tunnel endpoint obtains the second target network address from the second network addresses stored in the updated second database, so that the second target network address is the latest second network address, which improves the accuracy of the second target network address to a certain extent.

In some embodiments, after step 1301, the method further includes steps 1401 and 1402.

In step 1401, a preset second timing parameter is set to zero, and the second timing parameter is controlled to restart timing, where the second timing parameter is configured to characterize an unupdated duration of the second database.

In step 1402, the second network addresses stored in the second database are deleted in response to the second timing parameter being greater than a preset duration threshold.

In some embodiments of the present disclosure, the unupdated duration of the second database can be counted through the second timing parameter. After the second timing parameter is set to zero and the timing is restarted, the unupdated duration of the second database can be automatically recorded. The unupdated duration of the second database represents the duration that the second network addresses stored in the second database have not been updated.

In some embodiments of the present disclosure, after updating the second network addresses stored in the second database, the second tunnel endpoint can set the second timing parameter to zero, for example, assign the second timing parameter to zero, and control the second timing parameter to restart timing, so that the second timing parameter can automatically record the unupdated duration of the second database.

In some embodiments of the present disclosure, when the second timing parameter is greater than the preset duration threshold, it can indicate that the second network addresses stored in the second database have expired, and the second network addresses stored in the second database can be deleted, so as to reduce the resource occupation of the second database by the expired second network addresses and improve the resource utilization of the second database.

In some embodiments of the present disclosure, since the second timing parameter is used to represent the unupdated duration of the second database, when the second timing parameter is greater than the preset duration threshold, it represents that the unupdated duration of the second database has exceeded the preset duration threshold, and the second network addresses stored in the second database have timed out and not been updated. Further, by deleting the second network addressees stored in the second database, the resource occupation of the second database by the second network addresses that have timed out and not been updated might be reduced, which might improve the resource utilization of the second database to some extent.

In some embodiments, step 9031 may include steps 9031b and 9031c.

In step 9031b, a second address identifier is determined based on the second address request packet.

In step 9031c, a second network address corresponding to the second address identifier is obtained from the second network addresses stored in the second database based on the second address identifier, and the second network address is determined as the second target network address.

In some embodiments of the present disclosure, the second address request packet may be generated by the fourth device based on the known IP address of the target device to be accessed and the MAC address of the requested target device. The second address identifier can be the IP address of the target device in the second address request packet.

In some embodiments of the present disclosure, the second tunnel endpoint may perform a unpacking operation on the second address request packet to obtain the IP address of the target device in the second address request packet as the second address identifier. The second tunnel endpoint can search for the MAC address of the target device corresponding to the IP address of the target device from the second database based on the IP address of the target device, and determine the found MAC address of the target device, i.e., the second network address corresponding to the second address identifier, as the second target network address.

In some embodiments of the present disclosure, since the second address identifier is determined based on the second address request packet, the second address identifier matches the second network address requested by the second address request packet. Further, based on the second address identifier, the second target network address can be conveniently determined from the second database, which might improve the efficiency of obtaining the second target network address to a certain extent.

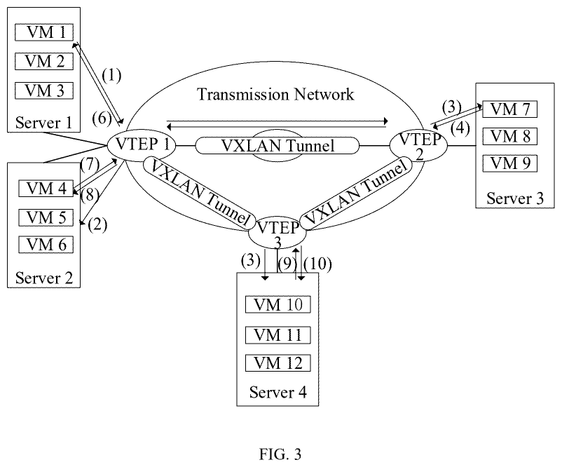

FIG. 3 is a schematic diagram of ARP request packet suppression in related art. In FIG. 3, (1) a virtual machine (VM) 1 sends an ARP request packet to obtain a MAC address of a VM 7. (2) After receiving the ARP request packet, a VTEP 1 creates an ARP suppression entry for the VM 1, floods the ARP request packet in the VXLAN network, and sends the ARP suppression entry of the VM 1 to a VTEP 2 and a VTEP 3 through a border gateway protocol (BGP) Ethernet virtual private network (EVPN), which is a transmission network in FIG. 3. (3) The VTEP 2 and the VTEP 3 decapsulate the ARP request packet and broadcast the ARP request packet locally. (4) A VM 7 sends an ARP reply to the VTEP 2. (5) The VTEP 2 creates an ARP suppression entry for the VM 7, forwards the ARP reply to the VTEP 1, and sends the ARP suppression entry of the VM 7 to the VTEP 1 and the VTEP 3 through the BGP EVPN. (6) The VTEP 1 decapsulates the ARP reply and forwards the ARP reply to the VM 1. (7) A VM 4 sends an ARP request packet to obtain a MAC address of the VM 1. (8) The VTEP 1 creates an ARP suppression entry for the VM 4 and replies to the ARP request packet of the VM 4 based on the ARP suppression entry of the VM 1. (9) A VM 10 sends an ARP request packet to obtain the MAC address of the VM 1. (10) The VTEP 3 creates an ARP suppression entry for the VM 10 and replies to the ARP request packet of the VM 10 based on the ARP suppression entry of the VM 1.

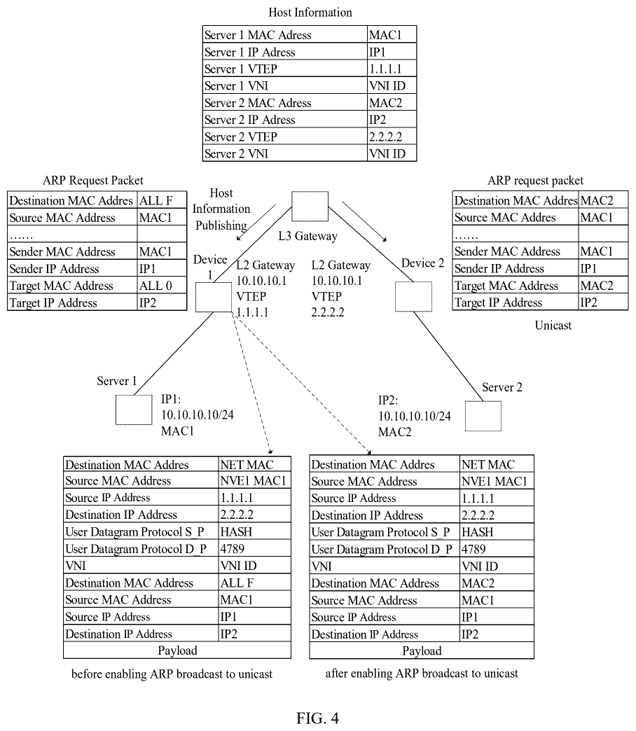

FIG. 4 is a schematic diagram of ARP broadcast suppression in the related art. As shown in FIG. 4, a VXLAN layer 3 gateway L3 can dynamically learn ARP suppression entries of a server 1 and a server 2, and generate host information based on the ARP suppression entries. The host information includes respective host IP addresses, MAC addresses, VTEP addresses, and virtual local area network extension identifiers (VNI IDs) of the server 1 and the server 2. The host information is published externally through a BGP EVPN, so that other BGP neighbors such as a VXLAN layer 2 gateway L2 in FIG. 4 can learn the host information of the L3 gateway. The host information learned by the VXLAN layer 2 gateway L2 can be used for broadcast suppression. Specifically, when the server 1 accesses the server 2 for the first time, the server 1 sends an address resolution protocol (ARP) request packet to the server 2, requesting the MAC address of the destination host, the server 2. A device 1, as a VXLAN layer 2 gateway, queries the host information after receiving the ARP request packet. If there is the MAC address of the destination host in the device 1, the device 1 replaces the broadcast destination MAC address in the ARP request packet with the MAC address of the destination host, and performs VXLAN encapsulation before forwarding. If there is no destination host information in the device 1, the broadcast destination MAC address in the ARP request packet remains unchanged, and the device 1 performs VXLAN encapsulation before forwarding. After receiving the unicast ARP request packet, the server 2 makes an ARP response. The server 1 receives an ARP response packet sent by the server 2 and establishes an ARP suppression entry, and can communicate with the server 2. In related art, by enabling ARP broadcast to unicast, the number of broadcast ARP packets might be suppressed, and the flooding of broadcast packets in the layer 2 of the VXLAN network might be prevented.

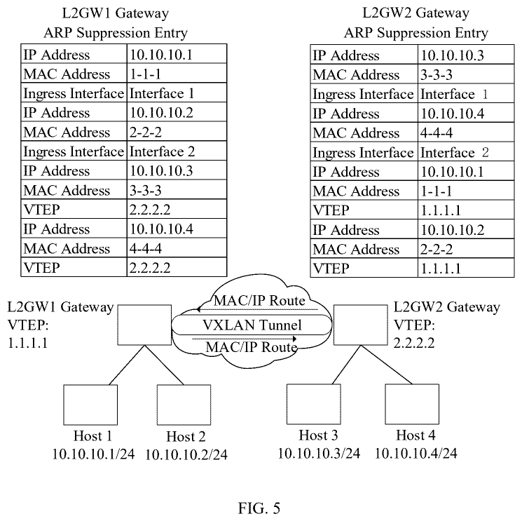

FIG. 5 is a schematic diagram of an ARP proxy reply in the related art. As shown in FIG. 5, after a layer 2 gateway device such as a L2GW1 gateway and a L2GW2 gateway in FIG. 5 enabling an ARP layer 2 proxy reply function based on broadcast domain (BD), when receiving an ARP request packet, a source IP address, a source MAC address, an ingress interface of the packet and other information in the ARP request packet will be recorded in a local address resolution protocol (ARP) suppression entry as a basis for subsequent ARP layer 2 proxy replies. When the layer 2 gateway device receives an ARP request packet again, the layer 2 gateway device first searches for the local ARP suppression entry (including locally listening and synchronized from other gateways) based on a destination IP in the ARP request packet. If a destination MAC address is found successfully, the ARP request packet will be directly proxy replied with the found destination MAC address. If the search fails, the ARP request packet will be processed according to an original procedure. This might significantly reduce ARP broadcast packets in the VXLAN network. A VXLAN tunnel can access remote host information by using information published by BGP Type2 (MAC/IP) routing. From ARP suppression entries in FIG. 5, it can be seen that the L2GW1 gateway has learned MAC/IP addresses of remote hosts 3 and 4. When the ARP proxy reply function of the layer 2 gateway device is enabled, an ARP request packet from a host 1 to access the host 3 or host 4 will be directly proxy replied by the L2GW1 gateway. The VXLAN tunnel might realize ARP suppression and proxy reply function by means of a BGP control plane.

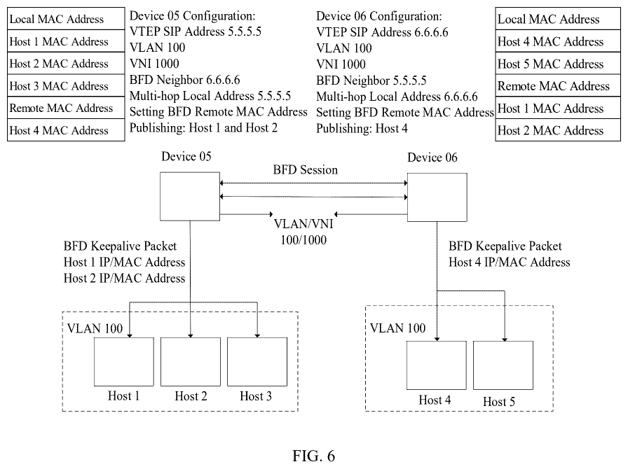

FIG. 6 is a schematic diagram of bidirectional forwarding detection (BFD) remote MAC address publishing provided by some embodiments of the present disclosure. As shown in FIG. 6, a device 05 is the first tunnel endpoint in the embodiments of the present disclosure, and a device 06 is the second tunnel endpoint in the embodiments of the present disclosure. There is a BFD session established between the device 05 and the device 06, and packets from a virtual local area network (VLAN) 100 in a same network segment can pass through a VXLAN static tunnel between the device 05 and the device 06, and carry a VXLAN network identifier (VNI), i.e., identifier (ID) 1000 of the VXLAN, reach the peer for access and to obtain a response. In FIG. 6, a host 1, a host 2, and a host 3 are the third devices corresponding to the first tunnel endpoint in the embodiments of the present disclosure, and a host 4 and a host 5 are the first devices corresponding to the second tunnel endpoint in the embodiments of the present disclosure. The device 05 learns IP/MAC addresses of the host 1, the host 2, and the host 3, and a source VTEP IP (VTEP SIP) address, a VXLAN network identifier (VNI), bidirectional forwarding detection (BFD) neighbor information are configured on the device 05. The BFD neighbor information includes BFD neighbor 6.6.6.6 and multi-hop local address 5.5.5.5, as well as setting BFD remote MAC address publishing: the host 1 and the host 2. After a BFD session is established between the device 05 and the device 06, the BFD session can be ensured to be in a hold state by sending a BFD keep alive packet (BFD Hello packet). The suffix in the BFD keep alive packet carries the IP/MAC addresses of the host 1 and the host 2, a VLAN channel name and a VNI channel identifier, i.e., 100/1000 in FIG. 6, which are sent to the BFD neighbor, i.e., the device 06. After receiving the BFD keep alive packet sent by the device 05, the device 06 can obtain remote MAC address entry information of the device 05, that is, the MAC addresses of the host 1 and the host 2. Further, the device 06 can enable a VXLAN proxy reply function by issuing a Linux (operating system kernel) instruction to the kernel, that is, perform a proxy reply to an ARP request packet requesting the MAC addresses of the host 1 and the host 2, realizing the ARP proxy reply of the VXLAN static tunnel, avoiding the problem of packet flooding caused by broadcasting, and suppressing the number of packets in the VXLAN network.

For example, the host 4 may be a device that sends the second address request packet (i.e., an ARP request packet) to the second tunnel endpoint (i.e., the device 06) in some embodiments of the present disclosure. The host 4 wants to access the host 1 corresponding to the first tunnel endpoint (i.e., device 05), and the host 4 sends an ARP request packet. When the device 06 has enabled the VXLAN proxy reply function, the device 06 can obtain the MAC address of the host 1 by looking up the entry and reply the MAC address of the host 1 to the host 4. Similarly, the device 06 can carry the IP/MAC address of the host 4 in the suffix of the BFD keep alive packet. After receiving the BFD keep alive packet sent by the device 06, the device 05 can obtain the MAC address of the host 4. The device 05 can perform a proxy reply to an ARP request packet requesting the MAC address of the host 4.

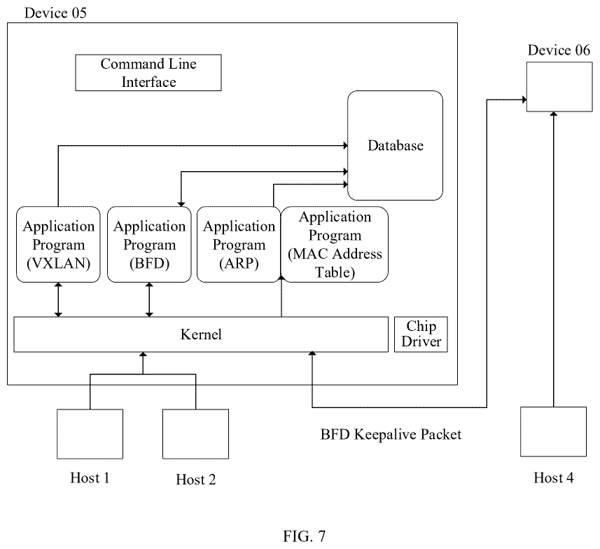

FIG. 7 is a schematic architectural diagram of service devices provided by some embodiments of the present disclosure. As shown in FIG. 7, a BFD session state is maintained between a device 05 and a device 06 by sending a BFD keep alive packet (BFD Hello packet). A host 4 is used as a setting for remote MAC address publishing by the device 06, and a host 1 and a host 2 are used as settings for remote MAC address publishing by the device 05. In FIG. 7, an application program (MAC address table) is used to learn local MAC addresses such as MAC addresses of the host 1 and the host 2. An application program (address resolution protocol) is used to determine the correspondence between IP addresses and MAC addresses of the host 1 and the host 2, and then write the IP/MAC addresses of the host 1 and the host 2 into a database shared by the application programs, that is, the first database in the embodiments of the present disclosure, for other application programs (such as an application program bidirectional forwarding detection) to obtain. The application program (bidirectional forwarding detection) is used to establish a BFD session between the device 05 and the device 06. The application program (bidirectional forwarding detection) can obtain the IP/MAC addresses of the host 1 and the host 2, a VXLAN tunnel name, and a VLAN/VNI tunnel identifier that need to be published from the first database, and packet them to obtain a BFD keep alive packet (BFD Hello packet). The BFD keep alive packet is sent to the device 06. The application program (bidirectional forwarding detection) receives information such as the IP/MAC address of the host 4, the VXLAN tunnel name, and the VLAN/VNI tunnel identifier published by the device 06, and stores the information in the first database for the application program (VXLAN) to obtain. The application (VXLAN) can perform tunnel identification and VNI matching on the device 06 based on the VXLAN tunnel name and the VLAN/VNI tunnel identifier.

For example, the host 1 may be the device that sends the first address request packet, i.e., the ARP request packet, to the first tunnel endpoint (the device 05) in the embodiments of the present disclosure. After the device 05 enables the VXLAN proxy reply function by issuing a Linux instruction to the kernel through a command line interface, when the host 1 wants to send an ARP request packet for the host 4 corresponding to the second tunnel endpoint (i.e., the device 06), the device 05 can obtain the MAC address of the host 4 from the first database and directly perform a proxy reply to the ARP request packet sent by the host 1.

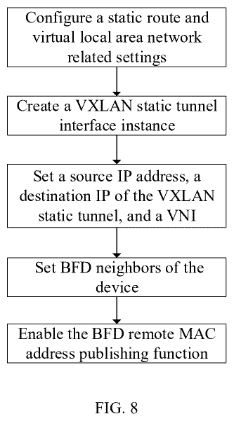

FIG. 8 is a schematic diagram of a service control flow provided by some embodiments of the present disclosure. As shown in FIG. 8, a static route and virtual local area network related settings are first configured, and then a VXLAN static tunnel interface instance is created. The specific configuration and creation methods can refer to the relevant descriptions in the related art, which are not limited in the embodiments of the present disclosure. After a VXLAN static tunnel is created, a source IP address of the VXLAN static tunnel, a destination VTEP IP (VTEP DIP), a VXLAN network identifier (VNI), and BFD neighbors of a device can be set, as shown in the relevant settings of the device 05 and the device 06 in FIG. 6. This is only an example, and some embodiments of the present disclosure do not limit this. After enabling the BFD remote MAC address publishing function, the device can send MAC addresses of one or more local hosts to a peer device on the tunnel and receive the MAC address of a remote host published by the peer device on the tunnel. The device can perform a proxy reply to an ARP request packet requesting the remote host and reply the MAC address of the remote host to a device that sent the ARP request packet.

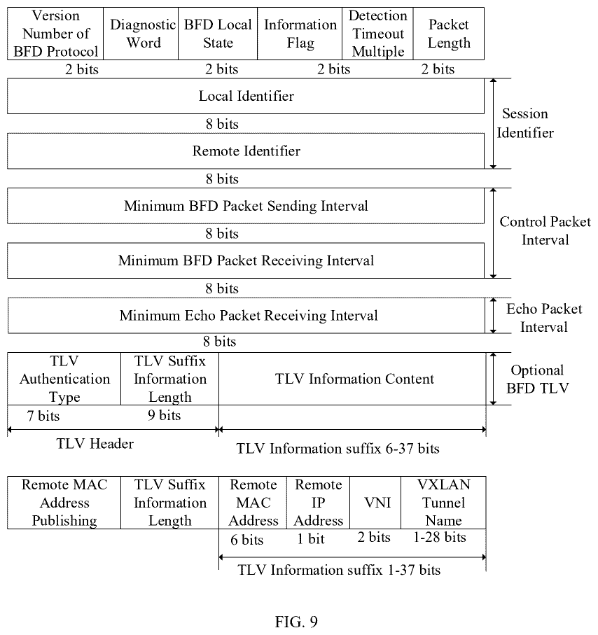

FIG. 9 is a schematic diagram of a BFD keep alive packet carrying a remote MAC address provided by some embodiments of the present disclosure. As shown in FIG. 9, a packet format of the BFD keep alive packet includes: a version number of a BFD protocol, a diagnostic word, a BFD local state, information flag, a detection timeout multiple, a packet length, and a local identifier and a remote identifier in session identifiers, a minimum BFD packet sending interval and a minimum BFD packet receiving interval in control packet intervals, a minimum echo packet receiving interval in echo packet intervals, as well as an optional BFD Type-Length-Value (TLV) added in the optional content of the BFD packet in the embodiments of the present disclosure. The optional TLV in the BFD packet includes a TLV authentication type, a TLV suffix information length, and TLV information contents. The TLV authentication type is remote MAC address publishing, and the TLV information contents include a remote MAC address, a remote IP address, a VXLAN ID, and a VXLAN tunnel name.

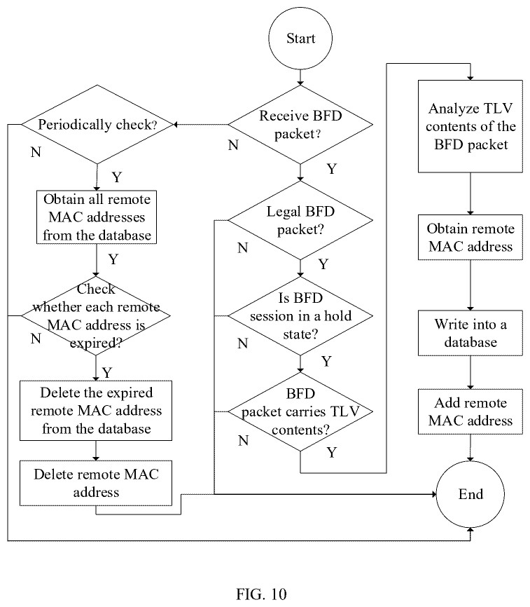

FIG. 10 is a schematic diagram of a control flow of a BFD remote MAC address provided in some embodiments of the present disclosure. As shown in FIG. 10, a first tunnel endpoint receives a first detection packet, or a second tunnel endpoint receives a second detection packet. The first detection packet and the second detection packet may be bidirectional forwarding detection (BFD) packets. The first tunnel endpoint or the second tunnel endpoint can determine whether the BFD packets are legal packets. The legality determination of a packet can refer to the related art. Some embodiments of the present disclosure do not limit this. After the legality is verified, it is determined whether the session between the first tunnel endpoint and the second tunnel endpoint is in a hold state. If the session is in a hold state, it is further determined whether the BFD packet carries TLV contents. In the case where the BFD packet carries the TLV contents, one or more remote MAC addresses carried in the TLV contents are analyzed and obtained, and the obtained MAC addresses are written into a respective database corresponding to the first tunnel endpoint or the second tunnel endpoint. The first tunnel endpoint or the second tunnel endpoint can issue a Linux instruction to the kernel, instructing the kernel to add the MAC addresses, and needs to perform proxy replies to address request packets that request the MAC addresses. The first tunnel endpoint or the second tunnel endpoint can periodically check the database, check whether each MAC address is expired by obtaining all the MAC addresses in the database, and delete the expired remote MAC address from the database. The first tunnel endpoint or the second tunnel endpoint can issue a Linux instruction to the kernel to instruct the kernel to delete the expired MAC address. In some embodiments, the Linux add instruction may be as follows:

bridge fdb add $REMOTE_MAC dev $VXLAN_TUNNEL $VLAN_ID master

bridge fdb add $REMOTE_MAC dev $VXLAN_TUNNEL dst $DIP self

In some embodiments, the Linux delete instruction may be as follows:

bridge fdb del $REMOTE_MAC dev $VXLAN_TUNNEL $VLAN_ID master

bridge fdb del $REMOTE_MAC dev $VXLAN_TUNNEL dst $DIP self

This is only an example, and some embodiments of the present disclosure do not limit this.

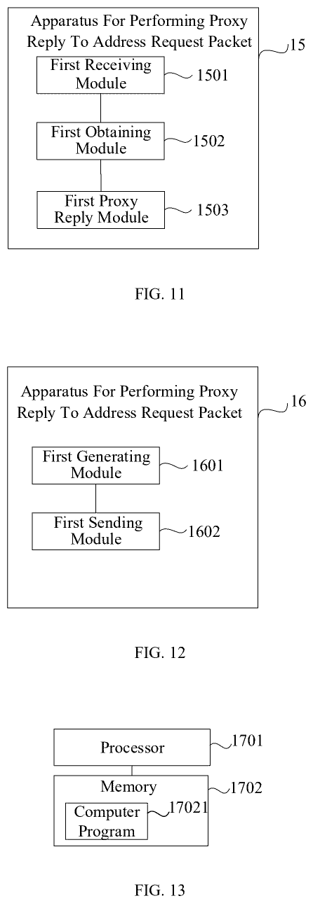

Referring to FIG. 11, some embodiments of the present disclosure provide an apparatus for performing a proxy reply to an address request packet, applied to a first tunnel endpoint, and the apparatus 15 includes:

a first receiving module 1501, configured to receive a first detection packet sent by a second tunnel endpoint;

a first obtaining module 1502, configured to obtain first network addresses carried by the first detection packet, where the first detection packet is generated by the second tunnel endpoint based on the first network addresses stored by the second tunnel endpoint, and the first network addresses are network addresses of one or more first devices corresponding to the second tunnel endpoint; and

a first proxy reply module 1503, configured to, in response to receiving a first address request packet, obtain a first target network address from the first network addresses and send the first target network address to a second device to perform a proxy reply to the first address request packet, where the first target network address is a first network address requested by the first address request packet, and the second device is a device that sends the first address request packet to the first tunnel endpoint.

In some embodiments, the apparatus 15 further includes:

a second generating module, configured to generate a second detection packet based on second network addresses stored by the first tunnel endpoint, where the second network addresses are network addresses of one or more third devices corresponding to the first tunnel endpoint; and

a second sending module, configured to send the second detection packet to the second tunnel endpoint, where the second detection packet is configured for the second tunnel endpoint to obtain the second network addresses carried by the second detection packet, and in response to receiving a second address request packet, obtain a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint.

In some embodiments, a static tunnel is established between the first tunnel endpoint and the second tunnel endpoint, and the apparatus 15 further includes:

a second obtaining module, configured to obtain a tunnel name and a tunnel identifier of the static tunnel;

where the second generating module is specifically configured to:

generate the second detection packet based on the second network addresses stored by the first tunnel endpoint, the tunnel name, and the tunnel identifier;

the second sending module is specifically configured to:

determine a first target tunnel from a plurality of static tunnels corresponding to the first tunnel endpoint based on the tunnel name and the tunnel identifier; and

send the second detection packet to the second tunnel endpoint through the first target tunnel.

In some embodiments, the apparatus 15 further includes:

a first session module, configured to, before the second generating module generates the second detection packet based on the second network addresses stored by the first tunnel endpoint, the tunnel name, and the tunnel identifier, establish a session between the first tunnel endpoint and the second tunnel endpoint based on the tunnel name and the tunnel identifier;

where the second sending module is specifically configured to:

send the second detection packet to the second tunnel endpoint through the first target tunnel under a condition that the session is in a hold state.

In some embodiments, the apparatus 15 further includes:

a first storage module, configured to store the first network addresses in a first database after the first obtaining module 1502 obtains the first network addresses carried by the first detection packet;

where the first proxy reply module 1503 is specifically configured to:

obtain the first target network address from the first network addresses stored in the first database and send the first target network address to the second device.

In some embodiments, the apparatus 15 further includes:

a first update module, configured to, in response to receiving a third detection packet sent by the second tunnel endpoint, update the first network addresses stored in the first database based on latest first network addresses carried by the third detection packet to obtain an updated first database, where the third detection packet is generated by the second tunnel endpoint based on the latest first network addresses;

where the first proxy reply module 1503 is specifically configured to obtain the first target network address from the first network addresses stored in the updated first database.

In some embodiments, the apparatus 15 further includes:

a first timing module, configured to, after the first update module updates the first network addresses stored in the first database based on the latest first network addresses carried by the third detection packet to obtain the updated first database, set a preset first timing parameter to zero, and control the first timing parameter to restart timing, where the first timing parameter is configured to characterize an unupdated duration of the first database; and

a first deletion module, configured to delete the first network addresses stored in the first database in response to the first timing parameter being greater than a preset duration threshold.

In some embodiments, the first proxy reply module 1503 is specifically configured to:

determine a first address identifier based on the first address request packet; and

obtain a first network address corresponding to the first address identifier from the first network addresses stored in the first database based on the first address identifier, and determining the first network address as the first target network address.

Referring to FIG. 12, some embodiments of the present disclosure provide another apparatus for performing a proxy reply to an address request packet, applied to a second tunnel endpoint, and the apparatus 16 includes:

a first generating module 1601, configured to generate a first detection packet based on first network addresses stored by the second tunnel endpoint, where the first network addresses are network addresses of one or more first devices corresponding to the second tunnel endpoint; and

a first sending module 1602, configured to send the first detection packet to a first tunnel endpoint, where the first detection packet is configured for the first tunnel endpoint to obtain the first network addresses, and in response to receiving a first address request packet, obtain a first target network address from the first network addresses and send the first target network address to a second device to perform a proxy reply to the first address request packet, where the first target network address is a first network address requested by the first address request packet, and the second device is a device that sends the first address request packet to the first tunnel endpoint.

In some embodiments, the apparatus 16 further includes:

a second receiving module, configured to receive a second detection packet sent by the first tunnel endpoint;

a third obtaining module, configured to obtain second network addresses carried by the second detection packet, where the second detection packet is generated by the first tunnel endpoint based on the second network addresses stored by first tunnel endpoint, and the second network addresses are network addresses of one or more third devices corresponding to the first tunnel endpoint; and

a second proxy reply module, configured to, in response to receiving a second address request packet, obtaining a second target network address from the second network addresses and send the second target network address to a fourth device to perform a proxy reply to the second address request packet, where the second target network address is a second network address requested by the second address request packet, and the fourth device is a device that sends the second address request packet to the second tunnel endpoint.

In some embodiments, a static tunnel is established between the first tunnel endpoint and the second tunnel endpoint, and the apparatus 16 further includes:

a fourth obtaining module, configured to obtain a tunnel name and a tunnel identifier of the static tunnel;

where the first generating module 1601 is specifically configured to:

generate the first detection packet based on the first network addresses stored by the second tunnel endpoint, the tunnel name, and the tunnel identifier;

the first sending module 1602 is specifically configured to:

determine a second target tunnel from a plurality of static tunnels corresponding to the second tunnel endpoint based on the tunnel name and the tunnel identifier; and

send the first detection packet to the first tunnel endpoint through the second target tunnel.

In some embodiments, the apparatus 16 further includes:

a second session module, configured to, before the first generating module 1601 generates the first detection packet based on the first network addresses stored by the second tunnel endpoint, the tunnel name, and the tunnel identifier, establish a session between the first tunnel endpoint and the second tunnel endpoint based on the tunnel name and the tunnel identifier;

where the first sending module 1602 is specifically configured to:

send the first detection packet to the first tunnel endpoint through the second target tunnel under a condition that the session is in a hold state.

In some embodiments, after obtaining the second network addresses carried by the second detection packet, the apparatus 16 further includes:

a second storage module, configured to store the second network addresses in a second database;

where the second proxy reply module is specifically configured to:

obtain the second target network address from the second network addresses stored in the second database and send the second target network address to the fourth device.

In some embodiments, the apparatus 16 further includes:

a second update module, configured to, in response to receiving a fourth detection packet sent by the first tunnel endpoint, update the second network addresses stored in the second database based on latest second network addresses carried by the fourth detection packet to obtain an updated second database, where the fourth detection packet is generated by the first tunnel endpoint based on the latest second network addresses;

where the second proxy reply module is specifically configured to:

obtain the second target network address from the second network addresses stored in the updated second database.

In some embodiments, after updating the second network addresses stored in the second database based on the latest second network addresses carried by the fourth detection packet to obtain the updated second database, the apparatus 16 further includes:

a second timing module, configured to set a preset second timing parameter to zero, and control the second timing parameter to restart timing, where the second timing parameter is configured to characterize an unupdated duration of the second database; and

a second deletion module, configured to delete the second network addresses stored in the second database in response to the second timing parameter being greater than a preset duration threshold.

In some embodiments, the second proxy reply module is specifically configured to:

determine a second address identifier based on the second address request packet; and

obtain a second network address corresponding to the second address identifier from the second network addresses stored in the second database based on the second address identifier, and determine the second network address as the second target network address.

The apparatuses for performing a proxy reply to an address request packet have the same advantages as the methods for performing a proxy reply to an address request packet described in the aforementioned embodiments compared with the related art, and will not be described in detail here.

For some apparatus embodiments, since they are basically similar to some method embodiments, the description is relatively simple, for the relevant contents, please refer to the descriptions of the method embodiments.

The present disclosure also provides an electronic device, as shown in FIG. 13, the electronic device includes a processor 1701, a memory 1702, and a computer program 17021 stored on the memory and running on the processor. The computer program, when executed by the processor, causes the electronic device to perform the method for performing a proxy reply to an address request packet in the aforementioned embodiments.

The present disclosure also provides a non-transitory readable storage medium, instructions in the non-transitory readable storage medium, when executed by a processor of an electronic device, cause the electronic device to perform the method for performing a proxy reply to an address request packet in the aforementioned embodiments.

The algorithms and demonstrations given here are not intrinsically associated with any particular computer, virtual system, or other device. Based on the above descriptions, architectures for constructing such a system are apparent. In addition, the present disclosure is not dependent on any particular programming language. It is understandable that various programming languages can be used to realize contents of the present disclosure described herein, and that the above descriptions concerning specific languages are intended to reveal the best implementation of the present disclosure.

In the description provided herein, numerous specific details are set forth. However, it can be understood that embodiments of the present disclosure may be practiced without these specific details. In other examples, well-known methods, structures and techniques have not been shown in detail in order not to obscure an understanding of this description.

Similarly, it should be appreciated that in order to simplify the present disclosure and help understand one or more of the various inventive aspects, in the above description of exemplary embodiments of the present disclosure, various features of the present disclosure are sometimes grouped together in a single embodiment, diagram, or description thereof. However, the method disclosed should not be interpreted as reflecting an intention that the claimed present disclosure requires more features than those expressly recited in each claim. More exactly, as the following claims reflect, inventive aspects include features less than all features of a single foregoing disclosed embodiment. Thus, the claims following the detailed description are hereby expressly incorporated into this detailed description, with each claim being an independent embodiment of the present disclosure.

Those skilled in the art can understand that it is possible to adaptively change the modules in the device in the embodiments and set them in one or more devices different from the embodiments. The modules or units or components in the embodiments can be combined into one module or unit or component, and in addition, they can be divided into multiple sub-modules or sub-units or sub-components. Except that at least some of such features and/or processes or units are mutually exclusive, any combination can be used to combine all features disclosed in this specification (including the accompanying claims, abstract and drawings) and all processes or units of any method or device disclosed in such a way. Unless expressly stated otherwise, each feature disclosed in this specification (including the accompanying claims, abstract and drawings) may be replaced by an alternative feature providing the same, equivalent or similar purpose.

Various component embodiments of the present disclosure may be realized in hardware or realized in software modules running on one or more processors or realized in combinations thereof. Those skilled in the art shall appreciate that some or all functions of some or all components in a sequencing device according to embodiments of the present disclosure may be realized by using a microprocessor or the digital signal processor (DSP) in practice. The present disclosure may also be realized as a part or all of devices or apparatus programs for performing the methods described herein. The programs for realizing the present disclosure may be stored on the computer readable medium or may have one or more signal forms. The signal may be downloaded from an Internet website or provided on a carrier signal or provided in any other forms.

It shall be noted that the above embodiments are used to describe the present disclosure rather than limiting the present disclosure. Moreover, those skilled in the art can design alternative embodiments without departing from the scope of the claims. In the claims, any reference numerals disposed in brackets shall not be constructed as the limitation to the claims. The word “include” refers to that elements or steps that are not listed in the claims are not excluded. “A” or “one” disposed in front of an element refers to that the existence of a plurality of such elements is not excluded. The present disclosure may be realized by means of hardware including a plurality of different elements and by means of the appropriately-programmed computer. In the unit claims listing several apparatuses, several of these apparatuses devices may be specifically realized through a same hardware item. The use of the words “first”, “second”, “third” and the like does not indicate any order. These words can be interpreted as names.

It may be clearly understood by those skilled in the art that, for the purpose of convenient and brief description, for a detailed working process of the foregoing system, apparatus, and unit, refer to a corresponding process in the foregoing method embodiments. Details are not described herein again.

The above is only the embodiments of the present disclosure and is not intended to limit the present disclosure. Any modifications, equivalent substitutions, and improvements made within the spirit and principles of the present disclosure should be included within the protection scope of the present disclosure.

The above is only the implementation of the present disclosure, but the protection scope of the present disclosure is not limited to this. Any skilled person familiar with the technical field can easily think of changes or replacements within the technical scope disclosed in the present disclosure, which should be included in the protection scope of the present disclosure. Therefore, the protection scope of the present disclosure should be based on the protection scope of the claims.

It should be noted that the relevant processes of obtaining various data in the embodiments of the present disclosure are carried out in accordance with the corresponding data protection regulations and policies of the country where they are located, and with authorization from the corresponding device owners.

1. A method for performing a proxy reply to an address request packet, applied to a first tunnel endpoint, the method comprising:
receiving a first detection packet sent by a second tunnel endpoint, wherein a static tunnel is established between the first tunnel endpoint and the second tunnel endpoint;
obtaining first network addresses carried by the first detection packet, wherein the first detection packet is generated by the second tunnel endpoint based on the first network addresses stored by the second tunnel endpoint and a tunnel name and a tunnel identifier of the static tunnel, and the first network addresses are network addresses of one or more first devices corresponding to the second tunnel endpoint; and
in response to receiving a first address request packet, obtaining a first target network address from the first network addresses and sending the first target network address to a second device to perform a proxy reply to the first address request packet, wherein the first target network address is a first network address requested by the first address request packet, and the second device is a device that sends the first address request packet to the first tunnel endpoint.

2. (canceled)

3. The method according to claim 1, further comprising:
generating a second detection packet based on second network addresses stored by the first tunnel endpoint, wherein the second network addresses are network addresses of one or more third devices corresponding to the first tunnel endpoint;
sending the second detection packet to the second tunnel endpoint, wherein the second detection packet is configured for the second tunnel endpoint to obtain the second network addresses carried by the second detection packet, and in response to receiving a second address request packet, obtain a second target network address from the second network addresses and send the second target network address to a fourth device to perform a proxy reply to the second address request packet, wherein the second target network address is a second network address requested by the second address request packet, and the fourth device is a device that sends the second address request packet to the second tunnel endpoint.

4. The method according to claim 3, further comprising:
obtaining the tunnel name and the tunnel identifier of the static tunnel;
wherein generating the second detection packet based on the second network addresses stored by the first tunnel endpoint comprises:
generating the second detection packet based on the second network addresses stored by the first tunnel endpoint, the tunnel name, and the tunnel identifier;
sending the second detection packet to the second tunnel endpoint comprises:
determining a first target tunnel from a plurality of static tunnels corresponding to the first tunnel endpoint based on the tunnel name and the tunnel identifier; and
sending the second detection packet to the second tunnel endpoint through the first target tunnel.

5. The method according to claim 4, wherein before generating the second detection packet based on the second network addresses stored by the first tunnel endpoint, the tunnel name, and the tunnel identifier, the method further comprises:
establishing a session between the first tunnel endpoint and the second tunnel endpoint based on the tunnel name and the tunnel identifier;
wherein sending the second detection packet to the second tunnel endpoint through the first target tunnel comprises:
sending the second detection packet to the second tunnel endpoint through the first target tunnel under a condition that the session is in a hold state.

6. The method according to claim 1, wherein after obtaining the first network addresses carried by the first detection packet, the method further comprises:
storing the first network addresses in a first database;
wherein obtaining the first target network address from the first network addresses and sending the first target network address to the second device comprises:
obtaining the first target network address from the first network addresses stored in the first database and sending the first target network address to the second device.

7. The method according to claim 6, further comprising:
in response to receiving a third detection packet sent by the second tunnel endpoint, updating the first network addresses stored in the first database based on latest first network addresses carried by the third detection packet to obtain an updated first database, wherein the third detection packet is generated by the second tunnel endpoint based on the latest first network addresses;
wherein obtaining the first target network address from the first network addresses stored in the first database comprises:
obtaining the first target network address from the first network addresses stored in the updated first database.

8. The method according to claim 7, wherein after updating the first network addresses stored in the first database based on the latest first network addresses carried by the third detection packet to obtain the updated first database, the method further comprises:
setting a preset first timing parameter to zero, and controlling the first timing parameter to restart timing, wherein the first timing parameter is configured to characterize an unupdated duration of the first database; and
deleting the first network addresses stored in the first database in response to the first timing parameter being greater than a preset duration threshold.

9. The method according to claim 6, wherein obtaining the first target network address from the first network addresses stored in the first database comprises:
determining a first address identifier based on the first address request packet; and
obtaining a first network address corresponding to the first address identifier from the first network addresses stored in the first database based on the first address identifier, and determining the first network address as the first target network address.

10. A method for performing a proxy reply to an address request packet, applied to a second tunnel endpoint, wherein a static tunnel is established between the second tunnel endpoint and a first tunnel endpoint, and the method comprises:
obtaining a tunnel name and a tunnel identifier of the static tunnel;
generating a first detection packet based on first network addresses stored by the second tunnel endpoint, the tunnel name, and the tunnel identifier wherein the first network addresses are network addresses of one or more first devices corresponding to the second tunnel endpoint;
sending the first detection packet to a first tunnel endpoint, wherein the first detection packet is configured for the first tunnel endpoint to obtain the first network addresses, and in response to receiving a first address request packet, obtain a first target network address from the first network addresses and send the first target network address to a second device to perform a proxy reply to the first address request packet, wherein the first target network address is a first network address requested by the first address request packet, and the second device is a device that sends the first address request packet to the first tunnel endpoint.

11. The method according to claim 10, further comprising:
receiving a second detection packet sent by the first tunnel endpoint;
obtaining second network addresses carried by the second detection packet, wherein the second detection packet is generated by the first tunnel endpoint based on the second network addresses stored by first tunnel endpoint, and the second network addresses are network addresses of one or more third devices corresponding to the first tunnel endpoint; and
in response to receiving a second address request packet, obtaining a second target network address from the second network addresses and send the second target network address to a fourth device to perform a proxy reply to the second address request packet, wherein the second target network address is a second network address requested by the second address request packet, and the fourth device is a device that sends the second address request packet to the second tunnel endpoint.

12. The method according to claim 10, wherein
sending the first detection packet to the first tunnel endpoint comprises:
determining a second target tunnel from a plurality of static tunnels corresponding to the second tunnel endpoint based on the tunnel name and the tunnel identifier; and
sending the first detection packet to the first tunnel endpoint through the second target tunnel.

13. The method according to claim 12, wherein before generating the first detection packet based on the first network addresses stored by the second tunnel endpoint, the tunnel name, and the tunnel identifier, the method further comprises:
establishing a session between the first tunnel endpoint and the second tunnel endpoint based on the tunnel name and the tunnel identifier;
wherein sending the first detection packet to the first tunnel endpoint through the second target tunnel comprises:
sending the first detection packet to the first tunnel endpoint through the second target tunnel under a condition that the session is in a hold state.

14. The method according to claim 11, wherein after obtaining the second network addresses carried by the second detection packet, the method further comprises:
storing the second network addresses in a second database;
wherein obtaining the second target network address from the second network addresses and send the second target network address to the fourth device comprises:
obtaining the second target network address from the second network addresses stored in the second database and sending the second target network address to the fourth device.

15. The method according to claim 14, further comprising:
in response to receiving a fourth detection packet sent by the first tunnel endpoint, updating the second network addresses stored in the second database based on latest second network addresses carried by the fourth detection packet to obtain an updated second database, wherein the fourth detection packet is generated by the first tunnel endpoint based on the latest second network addresses;
wherein obtaining the second target network address from the second network addresses stored in the second database comprises:
obtaining the second target network address from the second network addresses stored in the updated second database.

16. The method according to claim 15, after updating the second network addresses stored in the second database based on the latest second network addresses carried by the fourth detection packet to obtain the updated second database, the method further comprises:
setting a preset second timing parameter to zero, and controlling the second timing parameter to restart timing, wherein the second timing parameter is configured to characterize an unupdated duration of the second database; and
deleting the second network addresses stored in the second database in response to the second timing parameter being greater than a preset duration threshold.

17. The method according to claim 14, wherein obtaining the second target network address from the second network addresses stored in the second database comprises:
determining a second address identifier based on the second address request packet; and
obtaining a second network address corresponding to the second address identifier from the second network addresses stored in the second database based on the second address identifier, and determining the second network address as the second target network address.

18. (canceled)

19. (canceled)

20. An electronic device, comprising a processor, a memory, and a computer program stored on the memory and running on the processor, wherein the computer program, when executed by the processor, causes the electronic device to perform the method according to claim 1.

21. (canceled)

22. An electronic device, comprising a processor, a memory, and a computer program stored on the memory and running on the processor, wherein the computer program, when executed by the processor, causes the electronic device to perform the method according to claim 10.

23. A non-transitory readable storage medium, wherein instructions in the non-transitory readable storage medium, when executed by a processor of an electronic device, cause the electronic device to perform the method according to claim 1.

24. A non-transitory readable storage medium, wherein instructions in the non-transitory readable storage medium, when executed by a processor of an electronic device, cause the electronic device to perform the method according to claim 10.
